(19) United States
(12) Patent Application Publication
(10) Pub. No.: US 2025/0270132 A1
(43) Pub. Date: Aug. 28, 2025

(54) MICROCRYSTALLINE GLASS, MICROCRYSTALLINE GLASS PRODUCT AND MANUFACTURING METHOD THEREOF

(71) Applicant: CDGM GLASS CO., LTD, Chengdu, Sichuan (CN)

(72) Inventors: Baoping YUAN, Chengdu (CN); Sai LI, Chengdu (CN); Tianlai YU, Chengdu (CN); Dahong MO, Chengdu (CN); Yong SU, Chengdu (CN); Ying ZHANG, Chengdu (CN)

(73) Assignee: CDGM GLASS CO., LTD, Chengdu, Sichuan (CN)

(21) Appl. No.: 18/857,907

(22) PCT Filed: May 12, 2023
(86) PCT No.: PCT/CN2023/093852

§ 371 Date: Oct. 18, 2024

(30) Foreign Application Priority Data
Jun. 24, 2022 (CN) 202210722730.7

(51) Int. Cl. C03C 10/00; C03C 21/00

(52) U.S. Cl. CPC C03C 10/0027; C03C 21/001; C03C 2214/30

(57) ABSTRACT

A microcrystalline glass and microcrystalline glass product with excellent mechanic performance and lower haze. The microcrystalline glass product, wherein components thereof are represented by weight percentage, includes: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5. Through rational component design, the microcrystalline glass or microcrystalline glass product obtained by the present invention has excellent mechanic performance and lower haze, so as to be applicable for display devices or electronic devices with higher optical performance requirements.

### TECHNICAL FIELD

The present invention relates to a microcrystalline glass, in particular to a microcrystalline glass and microcrystalline glass product with excellent mechanic performance and lower haze, and manufacturing method thereof.

### BACKGROUND

In recent years, microcrystalline glass has been commonly used in various displays of many electronic products and display devices, such as mobile phone, music player, e-book reader, notepad, tablet, laptop, ATM and other similar devices. The materials used to form housings of the display devices and electronic devices are usually selected to meet the mechanical requirements associated with the end use of the electronic devices. On the other hand, electronic devices or display devices pose higher requirements on optical performance of the microcrystalline glass used therein. The optical performance refers to the performance of a substance when absorbing, reflecting and refracting light, such as haze, B value, and refractive index. However, the currently marketable microcrystalline glass has high haze, which is difficult to be applied to display devices or electronic devices with high optical performance requirements.

Therefore, the aim of scientific and technical personnel is to develop microcrystalline glass and microcrystalline glass product with excellent mechanical performance and lower haze that are applicable for display devices or electronic devices.

### SUMMARY

The technical problem to be solved by the present invention is to provide a microcrystalline glass and microcrystalline glass product with excellent mechanic performance and lower haze.

To solve the technical problem, the technical scheme of the present invention provides:
(1) A microcrystalline glass product, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.
(2) A microcrystalline glass product, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂.
(3) The microcrystalline glass product according to (1) or (2), wherein components thereof are represented by weight percentage, further comprising: 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.
(4) A microcrystalline glass product, comprising SiO₂, Al₂O₃, Li₂O, Na₂O, P₂O₅, and ZrO₂, wherein components thereof are represented by weight percentage, (SiO₂+Li₂O)/(ZrO₂+P₂O₅) is 4.0-15.5, and haze of the microcrystalline glass product with a thickness of below 1 mm is below 0.2%.
(5) A microcrystalline glass product, comprising SiO₂, Al₂O₃, Li₂O, Na₂O, and ZrO₂, wherein the microcrystalline glass product comprises lithium silicate crystalline phase, and the lithium silicate crystalline phase has a higher weight percentage than other crystalline phases.
(6) A microcrystalline glass product, comprising SiO₂, Al₂O₃, Li₂O, Na₂O, and ZrO₂, wherein the microcrystalline glass product comprises lithium monosilicate crystalline phase.
(7) The microcrystalline glass product according to any of (4)-(6), wherein components thereof are represented by weight percentage, comprising: 60-80% of SiO₂; and/or 3-15% of Al₂O₃; and/or greater than or equal to 5% but less than 10% of Li₂O; and/or 4-8% of Na₂O; and/or 0.5-5% of P₂O₅; and/or greater than 5% but less than or equal to 15% of ZrO₂; and/or 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.
(8) A microcrystalline glass product, wherein components thereof are represented by weight percentage, consisting of: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂; 0-2% of ZnO; 0-2% of MgO; 0-4% of B₂O₃; 0-3% of K₂O; 0-2% of Ln₂O₃; 0-2% of clarifying agent, and the Ln₂O₃ is one or more of La₂O₃, Gd₂O₃, Y₂O₃, and Yb₂O₃.
(9) The microcrystalline glass product according to any of (1)-(8), wherein components thereof are represented by weight percentage, and one or more of the following 5 conditions are satisfied:
1) SiO₂/ZrO₂ is 5.0-15.0, SiO₂/ZrO₂ is preferably 6.0-13.0, SiO₂/ZrO₂ is more preferably 6.5-12.0, and SiO₂/ZrO₂ is further preferably 7.0-11.0;
2) (SiO₂+Li₂O)/(ZrO₂+P₂O₅) is 5.0-13.5, (SiO₂+Li₂O)/(ZrO₂+P₂O₅) is preferably 6.0-11.5, (SiO₂+Li₂O)/(ZrO₂+P₂O₅) is more preferably 6.0-10.5;
3) (SiO₂+Al₂O₃+Na₂O)/Li₂O is 7.0-18.0, (SiO₂+Al₂O₃+Na₂O)/Li₂O is preferably 7.5-15.0, (SiO₂+Al₂O₃+Na₂O)/Li₂O is more preferably 8.5-13.0, (SiO₂+Al₂O₃+Na₂O)/Li₂O is further preferably 8.5-11.0;
4) (ZrO₂+Al₂O₃)/Li₂O is 0.85-5.0, (ZrO₂+Al₂O₃)/Li₂O is preferably 0.9-4.0, and (ZrO₂+Al₂O₃)/Li₂O is more preferably 1.0-3.5, (ZrO₂+Al₂O₃)/Li₂O is further preferably 1.0-3.0;
5) (Li₂O+Na₂O)/(SiO₂+ZrO₂) is 0.10-0.27, (Li₂O+Na₂O)/(SiO₂+ZrO₂) is preferably 0.12-0.25, (Li₂O+Na₂O)/(SiO₂+ZrO₂) is more preferably 0.14-0.25, (Li₂O+Na₂O)/(SiO₂+ZrO₂) is further preferably 0.15-0.23.
(10) The microcrystalline glass product according to any of (1)-(8), wherein components thereof are represented by weight percentage, comprising: 62-78% of SiO₂, preferably 64-75% of SiO₂; and/or 5-12% of Al₂O₃, preferably 5-10% of Al₂O₃; and/or greater than or equal to 6% but less than 10% of Li₂O; and/or 4-7.5% of Na₂O, preferably 4.5-7% of Na₂O; and/or 1-4.5% of P₂O₅, preferably 1.5-4% of P₂O₅; and/or 5.5-13% of ZrO₂, preferably 6-12% of ZrO₂; and/or 0-1.5% of ZnO, preferably 0-1% of ZnO; and/or 0-1.5% of MgO, preferably 0-1% of MgO; and/or 0-3% of B₂O₃, preferably 0-2% of B₂O₃; and/or 0-2% of K₂O, preferably 0-1% of K₂O; and/or 0-1% of Ln₂O₃, preferably 0-0.5% of Ln₂O₃; and/or 0-1% of clarifying agent, preferably 0-0.5% of clarifying agent, and the Ln₂O₃ is one or more of La₂O₃, Gd₂O₃, Y₂O₃, and Yb₂O₃.
(11) The microcrystalline glass product according to any of (1)-(8), wherein the microcrystalline glass product comprises lithium silicate crystalline phase, the lithium silicate crystalline phase has a higher weight percentage than other crystalline phases, preferably the lithium silicate crystalline phase accounts for 5-50% of the microcrystalline glass product by weight percentage, more preferably the lithium silicate crystalline phase accounts for 5-40% of the microcrystalline glass product by weight percentage, further preferably the lithium silicate crystalline phase accounts for 10-30% of the microcrystalline glass product by weight percentage.
(12) The microcrystalline glass product according to any of (1)-(8), wherein the microcrystalline glass product comprises lithium monosilicate crystalline phase, the lithium monosilicate crystalline phase has a higher weight percentage than other crystalline phases, preferably the lithium monosilicate crystalline phase accounts for 5-50% of the microcrystalline glass product by weight percentage, more preferably the lithium monosilicate crystalline phase accounts for 5-40% of the microcrystalline glass product by weight percentage, further preferably the lithium monosilicate crystalline phase accounts for 10-30% of the microcrystalline glass product by weight percentage.
(13) The microcrystalline glass product according to any of (1)-(8), wherein the microcrystalline glass product comprises lithium disilicate crystalline phase, the lithium disilicate crystalline phase accounts for below 20% of the microcrystalline glass product by weight percentage, preferably the lithium disilicate crystalline phase accounts for below 10% of the microcrystalline glass product by weight percentage, more preferably the lithium disilicate crystalline phase accounts for below 5% of the microcrystalline glass product by weight percentage, further preferably the lithium disilicate crystalline phase is not contained.
(14) The microcrystalline glass product according to any of (1)-(8), wherein the microcrystalline glass product comprises petalite crystalline phase, the petalite crystalline phase accounts for below 15% of the microcrystalline glass product by weight percentage, preferably the petalite crystalline phase accounts for below 10% of the microcrystalline glass product by weight percentage, more preferably the petalite crystalline phase accounts for below 5% of the microcrystalline glass product by weight percentage, further preferably the petalite crystalline phase is not contained.
(15) The microcrystalline glass product according to any of (1)-(8), wherein falling ball test height of the microcrystalline glass product is above 1400 mm, preferably above 1500 mm, more preferably above 1600 mm; and/or fracture toughness is above 1 MPa·m^{1/2} preferably above 1.1 MPa·m^{1/2}, more preferably above 1.2 MPa·m^{1/2}; and/or four-point bending strength is above 600 MPa, preferably above 650 MPa, more preferably above 700 MPa; and/or Vickers hardness is above 670 kgf/mm², preferably above 680 kgf/mm², more preferably above 700 kgf/mm²; and/or depth of ion exchange layer is above 80 μm, preferably above 90 μm, more preferably above 100 μm; and/or surface stress is above 100 MPa, preferably above 150 MPa, more preferably above 200 MPa; and/or crystallinity is above 10%, preferably above 15%, more preferably above 20%; and/or grain size is below 50 nm, preferably below 40 nm, more preferably below 30 nm; and/or drop resistance is above 1500 mm, preferably above 1600 mm, more preferably above 1800 mm.
(16) The microcrystalline glass product according to any of (1)-(8), wherein the haze of the microcrystalline glass product with a thickness of below 1 mm is below 0.2%, preferably below 0.17%, more preferably below 0.15%; and/or average light transmittance at 400-800 nm wavelength is above 88.0%, preferably above 89.0%, more preferably above 90.0%, further preferably above 90.5%; and/or light transmittance at 550 nm wavelength is above 89.0%, preferably above 90.0%, more preferably above 91.0%, further preferably above 91.5%; and/or average light |B| value at 400-800 nm is below 1.0, preferably below 0.9, more preferably below 0.8.
(17) The microcrystalline glass product according to (16), wherein the thickness of the microcrystalline glass product is 0.2-1 mm, preferably 0.3-0.9 mm, more preferably 0.5-0.8 mm, further preferably 0.55 mm or 0.6 mm or 0.68 mm or 0.7 mm or 0.75 mm.
(18) The microcrystalline glass product according to any of (1)-(7), wherein the microcrystalline glass product comprises colorant.
(19) The microcrystalline glass product according to (18), wherein the colorant is expressed by weight percentage, comprising: 0-4% of NiO; and/or 0-4% of Ni₂O₃; and/or 0-2% of CoO; and/or 0-2% of Co₂O₃; and/or 0-7% of Fe₂O₃; and/or 0-4% of MnO₂; and/or 0-8% of Er₂O₃; and/or 0-8% of Nd₂O₃; and/or 0-4% of Cu₂O; and/or 0-8% of Pr₂O₃; and/or 0-4% of CeO₂.
(20) A microcrystalline glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.
(21) A microcrystalline glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂.
(22) The microcrystalline glass according to (20) or (21), wherein components thereof are represented by weight percentage, further comprising: 0-2% of ZnO; and/or 0-2% of MgO; and/or 04% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.
(23) A microcrystalline glass, comprising SiO₂, Al₂O₃, Li₂O, Na₂O, P₂O₅, and ZrO₂, wherein components thereof are represented by weight percentage, (SiO₂+Li₂O)/(ZrO₂+P₂O₅) is 4.0-15.5, and haze of the microcrystalline glass with a thickness of below 1 mm is below 0.2%.
(24) A microcrystalline glass, comprising SiO₂, Al₂O₃, Li₂O, Na₂O, and ZrO₂, wherein the microcrystalline glass comprises lithium silicate crystalline phase, and the lithium silicate crystalline phase has a higher weight percentage than other crystalline phases.
(25) A microcrystalline glass, comprising SiO₂, Al₂O₃, Li₂O, Na₂O, and ZrO₂, wherein the microcrystalline glass comprises lithium monosilicate crystalline phase.
(26) The microcrystalline glass according to any of (23)-(25), wherein components thereof are represented by weight percentage, comprising: 60-80% of SiO₂; and/or 3-15% of Al₂O₃; and/or greater than or equal to 5% but less than 10% of Li₂O; and/or 4-8% of Na₂O; and/or 0.5-5% of P₂O₅; and/or greater than 5% but less than or equal to 15% of ZrO₂; and/or 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.
(27) A microcrystalline glass, wherein components thereof are represented by weight percentage, consisting of: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂; 0-2% of ZnO; 0-2% of MgO; 0-4% of B₂O₃; 0-3% of K₂O; 0-2% of Ln₂O₃; 0-2% of clarifying agent, and the Ln₂O₃ is one or more of La₂O₃, Gd₂O₃, Y₂O₃, and Yb₂O₃.
(28) The microcrystalline glass according to any of (20)-(27), wherein components thereof are represented by weight percentage, and one or more of the following 5 conditions are satisfied:
1) SiO₂/ZrO₂ is 5.0-15.0, SiO₂/ZrO₂ is preferably 6.0-13.0, SiO₂/ZrO₂ is more preferably 6.5-12.0, and SiO₂/ZrO₂ is further preferably 7.0-11.0;
2) (SiO₂+Li₂O)/(ZrO₂+P₂O₅) is 5.0-13.5, (SiO₂+Li₂O)/(ZrO₂+P₂O₅) is preferably 6.0-11.5, (SiO₂+Li₂O)/(ZrO₂+P₂O₅) is more preferably 6.0-10.5;
3) (SiO₂+Al₂O₃+Na₂O)/Li₂O is 7.0-18.0, (SiO₂+Al₂O₃+Na₂O)/Li₂O is preferably 7.5-15.0, (SiO₂+Al₂O₃+Na₂O)/Li₂O is more preferably 8.5-13.0, (SiO₂+Al₂O₃+Na₂O)/Li₂O is further preferably 8.5-11.0;
4) (ZrO₂+Al₂O₃)/Li₂O is 0.85-5.0, (ZrO₂+Al₂O₃)/Li₂O is preferably 0.9-4.0, and (ZrO₂+Al₂O₃)/Li₂O is more preferably 1.0-3.5, (ZrO₂+Al₂O₃)/Li₂O is further preferably 1.0-3.0;
5) (Li₂O+Na₂O)/(SiO₂+ZrO₂) is 0.10-0.27, (Li₂O+Na₂O)/(SiO₂+ZrO₂) is preferably 0.12-0.25, (Li₂O+Na₂O)/(SiO₂+ZrO₂) is more preferably 0.14-0.25, (Li₂O+Na₂O)/(SiO₂+ZrO₂) is further preferably 0.15-0.23.
(29) The microcrystalline glass according to any of (20)-(27), wherein components thereof are represented by weight percentage, comprising: 62-78% of SiO₂, preferably 64-75% of SiO₂; and/or 5-12% of Al₂O₃, preferably 5-10% of Al₂O₃; and/or greater than or equal to 6% but less than 10% of Li₂O; and/or 4-7.5% of Na₂O, preferably 4.5-7% of Na₂O; and/or 1-4.5% of P₂O₅, preferably 1.5-4% of P₂O₅; and/or 5.5-13% of ZrO₂, preferably 6-12% of ZrO₂; and/or 0-1.5% of ZnO, preferably 0-1% of ZnO; and/or 0-1.5% of MgO, preferably 0-1% of MgO; and/or 0-3% of B₂O₃, preferably 0-2% of B₂O₃; and/or 0-2% of K₂O, preferably 0-1% of K₂O; and/or 0-1% of Ln₂O₃, preferably 0-0.5% of Ln₂O₃; and/or 0-1% of clarifying agent, preferably 0-0.5% of clarifying agent, and the Ln₂O₃ is one or more of La₂O₃, Gd₂O₃, Y₂O₃, and Yb₂O₃.
(30) The microcrystalline glass according to any of (20)-(27), wherein the microcrystalline glass comprises lithium silicate crystalline phase, the lithium silicate crystalline phase has a higher weight percentage than other crystalline phases, preferably the lithium silicate crystalline phase accounts for 5-50% of the microcrystalline glass by weight percentage, more preferably the lithium silicate crystalline phase accounts for 5-40% of the microcrystalline glass by weight percentage, further preferably the lithium silicate crystalline phase accounts for 10-30% of the microcrystalline glass by weight percentage.
(31) The microcrystalline glass according to any of (20)-(27), wherein the microcrystalline glass comprises lithium monosilicate crystalline phase, the lithium monosilicate crystalline phase has a higher weight percentage than other crystalline phases, preferably the lithium monosilicate crystalline phase accounts for 5-50% of the microcrystalline glass by weight percentage, more preferably the lithium monosilicate crystalline phase accounts for 5-40% of the microcrystalline glass by weight percentage, further preferably the lithium monosilicate crystalline phase accounts for 10-30% of the microcrystalline glass by weight percentage.
(32) The microcrystalline glass according to any of (20)-(27), wherein the microcrystalline glass comprises lithium disilicate crystalline phase, the lithium disilicate crystalline phase accounts for below 20% of the microcrystalline glass by weight percentage, preferably the lithium disilicate crystalline phase accounts for below 10% of the microcrystalline glass by weight percentage, more preferably the lithium disilicate crystalline phase accounts for below 5% of the microcrystalline glass by weight percentage, further preferably the lithium disilicate crystalline phase is not contained.
(33) The microcrystalline glass according to any of (20)-(27), wherein the microcrystalline glass comprises petalite crystalline phase, the petalite crystalline phase accounts for below 15% of the microcrystalline glass by weight percentage, preferably the petalite crystalline phase accounts for below 10% of the microcrystalline glass by weight percentage, more preferably the petalite crystalline phase accounts for below 5% of the microcrystalline glass by weight percentage, further preferably the petalite crystalline phase is not contained.
(34) The microcrystalline glass according to any of (20)-(27), wherein crystallinity of the microcrystalline glass is above 10%, preferably above 15%, more preferably above 20%; and/or grain size is below 50 nm, preferably below 40 nm, more preferably below 30 nm; and/or body falling ball height is above 1700 mm, preferably above 1900 mm, more preferably above 2000 mm; and/or Vickers hardness is above 600 kgf/mm², preferably above 620 kgf/mm², more preferably above 630 kgf/mm²; and/or refractive index is 1.520-1.545; and/or Young's modulus is 80-100 GPa.
(35) The microcrystalline glass according to any of (20)-(27), wherein the haze of the microcrystalline glass with a thickness of below 1 mm is below 0.2%, preferably below 0.17%, more preferably below 0.15%; and/or average light transmittance at 400-800 nm wavelength is above 88.0%, preferably above 89.0%, more preferably above 90.0%, further preferably above 90.5%; and/or light transmittance at 550 nm wavelength is above 89.0%, preferably above 90.0%, more preferably above 91.0%, further preferably above 91.5%; and/or average light |B| value at 400-800 nm is below 1.0, preferably below 0.9, more preferably below 0.8.
(36) The microcrystalline glass according to (35), wherein the thickness of the microcrystalline glass is 0.2-1 mm, preferably 0.3-0.9 mm, more preferably 0.5-0.8 mm, further preferably 0.55 mm or 0.6 mm or 0.68 mm or 0.7 mm or 0.75 mm.
(37) The microcrystalline glass according to any of (20)-(26), wherein the microcrystalline glass comprises colorant.
(38) The microcrystalline glass according to (37), wherein the colorant is expressed by weight percentage, comprising: 0-4% of NiO; and/or 0-4% of Ni₂O₃; and/or 0-2% of COO; and/or 0-2% of Co₂O₃; and/or 0-7% of Fe₂O₃; and/or 0-4% of MnO₂; and/or 0-8% of Er₂O₃; and/or 0-8% of Nd₂O₃; and/or 0-4% of Cu₂O; and/or 0-8% of Pr₂O₃; and/or 0-4% of CeO₂.
(39) A matrix glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.
(40) A matrix glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂.
(41) The matrix glass according to (39) or (40), wherein components thereof are represented by weight percentage, further comprising: 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.
(42) A matrix glass, wherein components thereof are represented by weight percentage, consisting of: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂; 0-2% of ZnO; 0-2% of MgO; 0-4% of B₂O₃; 0-3% of K₂O; 0-2% of Ln₂O₃; 0-2% of clarifying agent, and the Ln₂O₃ is one or more of La₂O₃, Gd₂O₃, Y₂O₃, and Yb₂O₃.
(43) The matrix glass according to any of (39)-(42), wherein components thereof are represented by weight percentage, and one or more of the following 5 conditions are satisfied:
1) SiO₂/ZrO₂ is 5.0-15.0, SiO₂/ZrO₂ is preferably 6.0-13.0, SiO₂/ZrO₂ is more preferably 6.5-12.0, and SiO₂/ZrO₂ is further preferably 7.0-11.0;
2) (SiO₂+Li₂O)/(ZrO₂+P₂O₅) is 5.0-13.5, (SiO₂+Li₂O)/(ZrO₂+P₂O₅) is preferably 6.0-11.5, (SiO₂+Li₂O)/(ZrO₂+P₂O₅) is more preferably 6.0-10.5;
3) (SiO₂+Al₂O₃+Na₂O)/Li₂O is 7.0-18.0, (SiO₂+Al₂O₃+Na₂O)/Li₂O is preferably 7.5-15.0, (SiO₂+Al₂O₃+Na₂O)/Li₂O is more preferably 8.5-13.0, (SiO₂+Al₂O₃+Na₂O)/Li₂O is further preferably 8.5-11.0;
4) (ZrO₂+Al₂O₃)/Li₂O is 0.85-5.0, (ZrO₂+Al₂O₃)/Li₂O is preferably 0.9-4.0, and (ZrO₂+Al₂O₃)/Li₂O is more preferably 1.0-3.5, (ZrO₂+Al₂O₃)/Li₂O is further preferably 1.0-3.0;
5) (Li₂O+Na₂O)/(SiO₂+ZrO₂) is 0.10-0.27, (Li₂O+Na₂O)/(SiO₂+ZrO₂) is preferably 0.12-0.25, (Li₂O+Na₂O)/(SiO₂+ZrO₂) is more preferably 0.14-0.25, (Li₂O+Na₂O)/(SiO₂+ZrO₂) is further preferably 0.15-0.23.
(44) The matrix glass according to any of (39)-(42), wherein components thereof are represented by weight percentage, comprising: 62-78% of SiO₂, preferably 64-75% of SiO₂; and/or 5-12% of Al₂O₃, preferably 5-10% of Al₂O₃; and/or greater than or equal to 6% but less than 10% of Li₂O; and/or 4-7.5% of Na₂O, preferably 4.5-7% of Na₂O; and/or 1-4.5% of P₂O₅, preferably 1.5-4% of P₂O₅; and/or 5.5-13% of ZrO₂, preferably 6-12% of ZrO₂; and/or 0-1.5% of ZnO, preferably 0-1% of ZnO; and/or 0-1.5% of MgO, preferably 0-1% of MgO; and/or 0-3% of B₂O₃, preferably 0-2% of B₂O₃; and/or 0-2% of K₂O, preferably 0-1% of K₂O; and/or 0-1% of Ln₂O₃, preferably 0-0.5% of Ln₂O₃; and/or 0-1% of clarifying agent, preferably 0-0.5% of clarifying agent, and the Ln₂O₃ is one or more of La₂O₃, Gd₂O₃, Y₂O₃, and Yb₂O₃.
(45) The matrix glass according to any of (39)-(42), wherein refractive index of the matrix glass is 1.510-1.530.
(46) The matrix glass according to any of (39)-(41), wherein the matrix glass comprises colorant.
(47) The matrix glass according to (46), wherein the colorant is expressed by weight percentage, comprising: 0-4% of NiO; and/or 0-4% of Ni₂O₃; and/or 0-2% of CoO; and/or 0-2% of Co₂O₃; and/or 0-7% of Fe₂O₃; and/or 0-4% of MnO₂; and/or 0-8% of Er₂O₃; and/or 0-8% of Nd₂O₃; and/or 0-4% of Cu₂O; and/or 0-8% of Pr₂O₃; and/or 0-4% of CeO₂.
(48) A microcrystalline glass former, comprising the microcrystalline glass according to any of (20)-(38).
(49) A glass cover plate, comprising the microcrystalline glass product according to any of (1)-(19), and/or the microcrystalline glass according to any of (20)-(38), and/or the matrix glass according to any of (39)-(47), and/or the microcrystalline glass former according to (48).
(50) A glass component, comprising the microcrystalline glass product according to any of (1)-(19), and/or the microcrystalline glass according to any of (20)-(38), and/or the matrix glass according to any of (39)-(47), and/or the microcrystalline glass former according to (48).
(51) A display device, comprising the microcrystalline glass product according to any of (1)-(19), and/or the microcrystalline glass according to any of (20)-(38), and/or the matrix glass according to any of (39)-(47), and/or the microcrystalline glass former according to (48), and/or the glass cover plate according to (49), and/or the glass component according to (50).
(52) An electronic device, comprising the microcrystalline glass product according to any of (1)-(19), and/or the microcrystalline glass according to any of (20)-(38), and/or the matrix glass according to any of (39)-(47), and/or the microcrystalline glass former according to (48), and/or the glass cover plate according to (49), and/or the glass component according to (50).
(53) A manufacturing method of the microcrystalline glass product according to any of (1)-(19), wherein the method comprises the following steps: forming a matrix glass, forming the matrix glass into a microcrystalline glass through a crystallization process, and then forming the microcrystalline glass into a microcrystalline glass product through a chemical strengthening process.
(54) The manufacturing method of the microcrystalline glass product according to (53), wherein the crystallization process comprises the following steps: heating up to a specified crystallization treatment temperature, holding the temperature for a certain time after reaching the crystallization treatment temperature, and then performing cooling, wherein the crystallization treatment temperature is 550-700° C., preferably 580-650° C., and holding time under the crystallization treatment temperature is 0-8 hours, preferably 1-6 hours.
(55) The manufacturing method of the microcrystalline glass product according to (53), wherein the crystallization process comprises the following steps: performing nucleation process treatment under a first temperature, and then performing crystal growth process treatment under a second temperature that is higher than the nucleation process temperature.
(56) The manufacturing method of the microcrystalline glass product according to (55), wherein the crystallization process comprises the following steps: the first temperature is 450-550° C., and the second temperature is 550-700° C.; the holding time under the first temperature is 0-24 hours, preferably 2-15 hours; the holding time under the second temperature is 0-10 hours, preferably 0.5-6 hours.
(57) The manufacturing method of the microcrystalline glass product according to any of (53)-(56), wherein the chemical strengthening process comprises: immersing the microcrystalline glass into a salt bath of molten Na salt at a temperature of 350° C.-470° C. for 1-36 hours, wherein temperature range is preferably 380° C.-460° C., and time range is preferably 2-24 hours; and/or immersing the microcrystalline glass into a salt bath of molten K salt at a temperature of 360° C.-450° C. for 1-36 hours, wherein the time range is preferably 2-24 hours; and/or immersing the microcrystalline glass into a mixed salt bath of molten K salt and Na salt at a temperature of 360° C.-450° C. for 1-36 hours, wherein the time range is preferably 2-24 hours.
(58) A manufacturing method of the microcrystalline glass according to any of (20)-(38), wherein the method comprises the following steps: forming a matrix glass, and then forming the matrix glass into a microcrystalline glass through a crystallization process.
(59) The manufacturing method of the microcrystalline glass according to (58), wherein the crystallization process comprises the following steps: heating up to a specified crystallization treatment temperature, holding the temperature for a certain time after reaching the crystallization treatment temperature, and then performing cooling, wherein the crystallization treatment temperature is 550-700° C., preferably 580-650° C., and holding time under the crystallization treatment temperature is 0-8 hours, preferably 1-6 hours.
(60) The manufacturing method of the microcrystalline glass according to (59), wherein the crystallization process comprises the following steps: performing nucleation process treatment under a first temperature, and then performing crystal growth process treatment under a second temperature that is higher than the nucleation process temperature.
(61) The manufacturing method of the microcrystalline glass according to (60), wherein the crystallization process comprises the following steps: the first temperature is 450-550° C., and the second temperature is 550-700° C.; the holding time under the first temperature is 0-24 hours, preferably 2-15 hours; the holding time under the second temperature is 0-10 hours, preferably 0.5-6 hours.
(62) A manufacturing method of the microcrystalline glass former according to (48), wherein the method comprises: grinding or polishing the microcrystalline glass into a microcrystalline glass former, or making the matrix glass or microcrystalline glass into the microcrystalline glass former through hot bending process or pressing process at a certain temperature.
(63) The manufacturing method of the microcrystalline glass former according to (62), wherein the method comprises the following steps: performing a crystallization heat treatment process once for the matrix glass, including heating, heat preservation and nucleation, heating, heat preservation and crystallization, cooling to room temperature, and forming a precrystallized glass; and thermally processing the precrystallized glass to obtain the microcrystalline glass former.
(64) The manufacturing method of the microcrystalline glass former according to (62), wherein the method comprises the following steps:
1) heating and warm-up: placing the matrix glass or precrystallized glass or microcrystalline glass into a mould, making the mould pass through each heating site in a hot bending machine successively and stay at each site for a certain time for heat preservation, wherein temperature of warm-up zone is 400-800° C., pressure is 0.01-0.05 MPa, and time is 40-200 s;
2) pressing: transferring the mould to a molding site after warm-up, wherein the hot bending machine exerts a certain pressure on the mould, pressure range is 0.1-0.8 Mpa, temperature range of the molding site is 600-850° C., and molding time range is 40-200 s;
3) pressure holding and cooling: transferring the mould to a cooling site to cool down site by site, wherein cooling temperature range is 750-500° C., the pressure is 0.01-0.05 Mpa, and the time is 40-200 s.

The beneficial effects of the present invention are as follows: through rational component design, the microcrystalline glass or microcrystalline glass product obtained by the present invention has excellent mechanic performance and lower haze, so as to be applicable for display devices or electronic devices with higher optical performance requirements.

### DETAILED DESCRIPTION

The microcrystalline glass and microcrystalline glass product provided by the present invention are materials with crystalline phase (sometimes also called crystal) and glass phase, which are different from amorphous solid. The crystalline phase of the microcrystalline glass and microcrystalline glass product can be identified by peak angles appeared in X-ray diffraction pattern of X-ray diffraction analysis and/or measured by TEMEDX.

Through repeated tests and researches, the inventor of the present invention obtains the microcrystalline glass or microcrystalline glass product provided by the present invention at a lower cost by specifying the content and proportion of specific components constituting the microcrystalline glass and microcrystalline glass product as specific values and precipitating specific crystalline phases.

In the following paragraphs, the range of components (ingredients) of the matrix glass, microcrystalline glass and microcrystalline glass product provided by the present invention will be described. If not specified herein, the content of each component is expressed in weight percentage (wt %) relative to the total content of the matrix glass or microcrystalline glass or microcrystalline glass product converted into oxide composition. “Converted into oxide composition” therein refers to that the total content of this oxide is taken as 100% when the oxide, compound salt and hydroxide, used as raw materials for the composition of the matrix glass, microcrystalline glass or microcrystalline glass product provided by the present invention, are decomposed and transformed into oxides during melting. In addition, in this description, only the matrix glass before crystallization (i.e., crystallization process treatment) is referred to as glass, the crystallized (i.e., crystallization process treatment) matrix glass is referred to as microcrystalline glass, and the microcrystalline glass product refers to that obtained by chemical strengthening of the microcrystalline glass.

Unless otherwise noted in specific circumstances, the numerical range listed herein includes upper and lower limits, and the words “above” and “below” include the endpoint values as well as all integers and fractions within the range, but not limited to the specific values listed when the range is limited. The term “about” as used herein refers to that formulations, parameters and other quantities as well as characteristics are not, and do not need to be, accurate, and may be approximate and/or greater or lower if necessary, reflecting tolerances, conversion factors, measurement errors, etc. “And/or” mentioned herein is inclusive. For example, “A; and/or B” refers to only A, or only B, or both A and B.

In some embodiments of the present invention, the crystalline phase in the microcrystalline glass or microcrystalline glass product comprises lithium silicate crystalline phase (one or more of lithium monosilicate or lithium disilicate). In some embodiments, the lithium silicate crystalline phase has a higher weight percentage than other crystalline phases. In some embodiments, the lithium silicate crystalline phase accounts for 5-50% of the microcrystalline glass or microcrystalline glass product by weight percentage, preferably the lithium silicate crystalline phase accounts for 5-40% of the microcrystalline glass or microcrystalline glass product by weight percentage, more preferably the lithium silicate crystalline phase accounts for 10-30% of the microcrystalline glass or microcrystalline glass product by weight percentage. In some embodiments, the lithium silicate crystalline phase accounts for 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% and 50% of the microcrystalline glass or microcrystalline glass product by weight percentage.

In some embodiments of the present invention, the crystalline phase in the microcrystalline glass or microcrystalline glass product comprises lithium monosilicate crystalline phase. In some embodiments, the lithium monosilicate crystalline phase has a higher weight percentage than other crystalline phases. In some embodiments, the lithium monosilicate crystalline phase accounts for 5-50% of the microcrystalline glass or microcrystalline glass product by weight percentage, preferably the lithium monosilicate crystalline phase accounts for 5-40% of the microcrystalline glass or microcrystalline glass product by weight percentage, more preferably the lithium monosilicate crystalline phase accounts for 10-30% of the microcrystalline glass or microcrystalline glass product by weight percentage. In some embodiments, the lithium monosilicate crystalline phase accounts for 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% and 50% of the microcrystalline glass or microcrystalline glass product by weight percentage.

In some embodiments of the present invention, the crystalline phase in the microcrystalline glass or microcrystalline glass product comprises lithium disilicate crystalline phase. In some embodiments, the lithium disilicate crystalline phase accounts for below 20% of the microcrystalline glass or microcrystalline glass product by weight percentage, preferably the lithium disilicate crystalline phase accounts for below 10% of the microcrystalline glass or microcrystalline glass product by weight percentage, more preferably the lithium disilicate crystalline phase accounts for below 5% of the microcrystalline glass or microcrystalline glass product by weight percentage, further preferably the lithium disilicate crystalline phase is not contained in the microcrystalline glass or microcrystalline glass product. In some embodiments, the lithium disilicate crystalline phase accounts for 0%, greater than 0%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5% and 20% of the microcrystalline glass or microcrystalline glass product by weight percentage.

In some embodiments of the present invention, the crystalline phase in the microcrystalline glass or microcrystalline glass product comprises petalite crystalline phase, the petalite crystalline phase accounts for below 15% of the microcrystalline glass or microcrystalline glass product by weight percentage, preferably the petalite crystalline phase accounts for below 10% of the microcrystalline glass or microcrystalline glass product by weight percentage, more preferably the petalite crystalline phase accounts for below 5% of the microcrystalline glass or microcrystalline glass product by weight percentage, further preferably the petalite crystalline phase is not contained in the microcrystalline glass or microcrystalline glass product. In some embodiments, the petalite crystalline phase accounts for 0%, greater than 0%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% and 15% of the microcrystalline glass or microcrystalline glass product by weight percentage.

SiO₂, as a basic component of the glass, microcrystalline glass and microcrystalline glass product provided by the present invention, is one of the components forming the lithium silicate crystalline phase. If the content of SiO₂ is below 60%, the crystal is easy to become coarse in the microcrystalline glass, which affects the light transmittance of the microcrystalline glass and microcrystalline glass product. Therefore, the lower limit of the SiO₂ content is 60%, preferably 62%, more preferably 64%. If the content of SiO₂ is above 80%, the glass melting temperature is high, resulting in material melting difficulties, and the haze of the microcrystalline glass and microcrystalline glass product increases. Therefore, the upper limit of the content of SiO₂ is 80%, preferably 78%, more preferably 75%. In some embodiments, it can comprise about 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5% and 80% of SiO₂.

Al₂O₃, as a component that forms a glass network structure, is conducive to the chemical strengthening of the microcrystalline glass, and can improve the drop resistance of the microcrystalline glass product. If the content of Al₂O₃ is less than 3%, the above effect does not work well. Therefore, the lower limit of the Al₂O₃ content is 3%, preferably 5%. On the other hand, if the content of Al₂O₃ exceeds 15%, the broken fragments of the microcrystalline glass product obtained after chemical strengthening of microcrystalline glass are small (generally in a granular form), which is not conducive to continued use. Therefore, the upper limit of the content of Al₂O₃ is 15%, preferably 12%, more preferably 10%. In some embodiments, it can comprise about 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% and 15% of Al₂O₃.

Li₂O is a necessary component for the microcrystalline glass provided by the present invention to form the crystalline phase, and is also a necessary component for chemical strengthening. However, if the content of Li₂O is less than 5%, the type of crystal formation changes, which affects the strength of the microcrystalline glass and microcrystalline glass product. Therefore, the lower limit of the Li₂O content is 5%, preferably 6%. On the other hand, if excessive Li₂O is contained, the haze of the microcrystalline glass and microcrystalline glass product rises, and the raw material cost is higher. Therefore, the upper limit of Li₂O content is less than 10%. In some embodiments, it can comprise about 5%, 5.5%, 6%, 6.5%, 7%, 7.5%, 8%, 8.5%, 9%, 9.5%, 9.8% and less than 10% of Li₂O.

Na₂O is conductive to the formation of lithium monosilicate crystalline phase in the microcrystalline glass, and can improve the chemical stability after chemical strengthening of microcrystalline glass. The present invention achieves the above effect by comprising above 4% of Na₂O, preferably comprising above 4.5% of Na₂O. However, if excessive Na₂O is contained, it is difficult to form lithium monosilicate crystalline phase in the microcrystalline glass, which affects the light transmittance of the microcrystalline glass and microcrystalline glass product. Therefore, the upper limit of the content of Na₂O is 8%, preferably 7.5%, more preferably 7%. In some embodiments, it can comprise about 4%, 4.5%, 5%, 5.5%, 6%, 6.5%, 7%, 7.5% and 8% of Na₂O.

In some embodiments, the ratio (SiO₂+Al₂O₃+Na₂O)/Li₂O of the total content (SiO₂+Al₂O₃+Na₂O) of SiO₂, Al₂O₃ and Na₂O to the content of Li₂O is controlled to be within a range of 7.0-18.0, which is conductive to refining the crystal, improving the fracture toughness of the microcrystalline glass and microcrystalline glass product, and increasing the depth of ion exchange layer and surface stress of the microcrystalline glass product. Therefore, (SiO₂+Al₂O₃+Na₂O)/Li₂O is preferably 7.0-18.0, (SiO₂+Al₂O₃+Na₂O)/Li₂O is more preferably 7.5-15.0, (SiO₂+Al₂O₃+Na₂O)/Li₂O is further preferably 8.5-13.0, and (SiO₂+Al₂O₃+Na₂O)/Li₂O is more further preferably 8.5-11.0. In some embodiments, the value of (SiO₂+Al₂O₃+Na₂O)/Li₂O can be 7.0, 7.3, 7.5, 7.7, 8.0, 8.3, 8.5, 8.7, 9.0, 9.3, 9.5, 9.7, 10.0, 10.3, 10.5, 10.7, 11.0, 11.3, 11.5, 11.7, 12.0, 12.3, 12.5, 12.7, 13.0, 13.3, 13.5, 13.7, 14.0, 14.3, 14.5, 14.7, 15.0, 15.3, 15.5, 15.7, 16.0, 16.3, 16.5, 16.7, 17.0, 17.3, 17.5, 17.7 and 18.0.

ZrO₂ can prevent devitrification during glass molding, refine the crystal during crystallization heat treatment, and decrease the haze of the microcrystalline glass and microcrystalline glass product. In the present invention, the lower limit of the ZrO₂ content is greater than 5%, preferably above 5.5%, more preferably above 6%. However, if excessive ZrO₂ is contained, ZrO₂ is not easy to melt in the glass, and it is easy to form stones and weaken the heat treatment devitrification capacity of the glass. Therefore, the upper limit of the content of ZrO₂ is 15%, preferably 13%, more preferably 12%. In some embodiments, it can comprise about greater than 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% and 15% of ZrO₂.

In some embodiments, the ratio SiO₂/ZrO₂ of the content of SiO₂ to the content of ZrO₂ is controlled to be within a range of 5.0-15.0, which is conductive to improving the light transmittance and four-point bending strength of the microcrystalline glass and microcrystalline glass product, improving the falling ball test height of the microcrystalline glass product and the body falling ball height of the microcrystalline glass, and preventing the increase of the haze and |B| value. Therefore, SiO₂/ZrO₂ is preferably 5.0-15.0, SiO₂/ZrO₂ is more preferably 6.0-13.0, SiO₂/ZrO₂ is further preferably 6.5-12.0, and SiO₂/ZrO₂ is more further preferably 7.0-11.0. In some embodiments, the value of SiO₂/ZrO₂ can be 5.0, 5.3, 5.5, 5.7, 6.0, 6.3, 6.5, 6.7, 7.0, 7.3, 7.5, 7.7, 8.0, 8.3, 8.5, 8.7, 9.0, 9.3, 9.5, 9.7, 10.0, 10.3, 10.5, 10.7, 11.0, 11.3, 11.5, 11.7, 12.0, 12.3, 12.5, 12.7, 13.0, 13.3, 13.5, 13.7, 14.0, 14.3, 14.5, 14.7 and 15.0.

In some embodiments, the ratio (ZrO₂+Al₂O₃)/Li₂O of the total content (ZrO₂+Al₂O₃) of ZrO₂ and Al₂O₃ to the content of Li₂O is controlled to be within a range of 0.85-5.0, which can improve the body falling fall height of the microcrystalline glass, improve the falling ball test height and depth of ion exchange layer of the microcrystalline glass product, and prevent the decrease of light transmittance and crystallinity of the microcrystalline glass and microcrystalline glass product. Therefore, (ZrO₂+Al₂O₃)/Li₂O is preferably 0.85-5.0, ZrO₂+Al₂O₃)/Li₂O is more preferably 0.9-4.0, (ZrO₂+Al₂O₃)/Li₂O is further preferably 1.0-3.5, and (ZrO₂+Al₂O₃)/Li₂O is more further preferably 1.0-3.0. In some embodiments, the value of (ZrO₂+Al₂O₃)/Li₂O can be 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0.

In some embodiments, the ratio (Li₂O+Na₂O)/(SiO₂+ZrO₂) of the total content (Li₂O+Na₂O) of Li₂O and Na₂O to the total content (SiO₂+ZrO₂) of SiO₂ and ZrO₂ is controlled to be within a range of 0.10-0.27, which is conductive to improving the surface stress and depth of ion exchange layer of the microcrystalline glass product, improving the four-point bending strength and hardness of the microcrystalline glass and microcrystalline glass product, and preventing the decrease of fracture toughness and drop resistance of the microcrystalline glass and microcrystalline glass product. Therefore, (Li₂O+Na₂O)/(SiO₂+ZrO₂) is preferably 0.10-0.27, (Li₂O+Na₂O)/(SiO₂+ZrO₂) is more preferably 0.12-0.25, (Li₂O+Na₂O)/(SiO₂+ZrO₂) is further preferably 0.14-0.25, and (Li₂O+Na₂O)/(SiO₂+ZrO₂) is more further preferably 0.15-0.23. In some embodiments, the value of (Li₂O+Na₂O)/(SiO₂+ZrO₂) can be 0.10, 0.11, 0.12, 0.13, 0.14, 0.15, 0.16, 0.17, 0.18, 0.19, 0.20, 0.21, 0.22, 0.23, 0.24, 0.25, 0.26 and 0.27.

P₂O₅ can perform non-uniform nucleation in the glass, promote the formation of crystal, and improve the light transmittance of the microcrystalline glass and microcrystalline glass product. In the present invention, the lower limit of the P₂O₅ content is 0.5%, preferably 1%, more preferably 1.5%. However, if excessive P₂O₅ is contained, it is easy to have direct devitrification during glass molding, and the heat treatment process is not easy to control. Therefore, the upper limit of the content of P₂O₅ is 5%, preferably 4.5%, more preferably 4%. In some embodiments, it can comprise about 0.5%, 1%, 1.5%, 2%, 2.5%, 3%, 3.5%, 4%, 4.5% and 5% of P₂O₅.

In some embodiments, the ratio (SiO₂+Li₂O)/(ZrO₂+P₂O₅) of the total content (SiO₂+Li₂O) of SiO₂ and Li₂O to the total content (ZrO₂+P₂O₅) of ZrO₂ and P₂O₅ is controlled to be within a range of 4.0-15.5, which can decrease the haze and |B| value of the microcrystalline glass and microcrystalline glass product, improve the drop resistance and hardness of the microcrystalline glass and microcrystalline glass product, and optimize the crystallinity of the microcrystalline glass and microcrystalline glass product. Therefore, (SiO₂+Li₂O)/(ZrO₂+P₂O₅) is preferably 4.0-15.5, (SiO₂+Li₂O)/(ZrO₂+P₂O₅) is more preferably 5.0-13.5, (SiO₂+Li₂O)/(ZrO₂+P₂O₅) is further preferably 6.0-11.5, and (SiO₂+Li₂O)/(ZrO₂+P₂O₅) is more further preferably 6.0-10.5. In some embodiments, the value of (SiO₂+Li₂O)/(ZrO₂+P₂O₅) can be 4.0, 4.3, 4.5, 4.7, 5.0, 5.3, 5.5, 5.7, 6.0, 6.3, 6.5, 6.7, 7.0, 7.3, 7.5, 7.7, 8.0, 8.3, 8.5, 8.7, 9.0, 9.3, 9.5, 9.7, 10.0, 10.3, 10.5, 10.7, 11.0, 11.3, 11.5, 11.7, 12.0, 12.3, 12.5, 12.7, 13.0, 13.3, 13.5, 13.7, 14.0, 14.3, 14.5, 14.7, 15.0, 15.3 and 15.5.

ZnO can decrease the melting temperature of the glass, but excessive content thereof will lead to an increase in the haze of the microcrystalline glass and microcrystalline glass product. Therefore, the content of ZnO is confined to be below 2%, preferably below 1.5%, more preferably below 1%. In some embodiments, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9% and 2% of ZnO.

MgO can decrease the melting temperature of the glass, but excessive content thereof will lead to an increase in the haze of the microcrystalline glass and microcrystalline glass product. Therefore, the content of MgO is confined to be below 2%, preferably below 1.5%, more preferably below 1%. In some embodiments, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9% and 2% of MgO.

B₂O₃ can decrease the melting temperature of the glass, increase the content of glass phase in the microcrystalline glass, and facilitate the hot bending of the microcrystalline glass and microcrystalline glass product. However, if excessive B₂O₃ is contained in the glass, it is easy to separate phases during crystallization heat treatment, resulting in a decrease in the light transmittance of the microcrystalline glass and microcrystalline glass product. Thus, the content of B₂O₃ is 0 to 4%, preferably 0 to 3%, more preferably 0 to 2%. In some embodiments, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9% and 4% of B₂O₃.

K₂O can decrease the viscosity of the glass, and promote the growth of crystal during crystallization heat treatment. However, if excessive K₂O is contained, it is easy to make the crystal in the glass grow rapidly and decrease the light transmittance of the microcrystalline glass and microcrystalline glass product. Therefore, the content of K₂O is below 3%, preferably 2%, more preferably below 1%. In some embodiments, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9% and 3% of K₂O.

Ln₂O₃(Ln₂O₃ is one or more of La₂O₃, Gd₂O₃, Y₂O₃, and Yb₂O₃) can decrease the melting difficulty of the glass. In case of excessive content, it will lead to difficulty in crystal formation during glass crystallization, decrease in crystallinity of the microcrystalline glass and microcrystalline glass product, and decrease in body falling ball height of the microcrystalline glass and falling ball test height of the microcrystalline glass product. Therefore, the upper limit of Ln₂O₃ is 2%, preferably 1%, more preferably 0.5%, further preferably 0%. In some embodiments, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9% and 2% of Ln₂O₃.

In some embodiments, the glass, microcrystalline glass or microcrystalline glass product may also comprise 0-2% of clarifying agent, in order to improve the defoaming capacity of the glass, microcrystalline glass or microcrystalline glass product. Such clarifying agent includes, but is not limited to, one or more of Sb₂O₃, SnO₂, SnO, CeO₂, F (fluorine), Cl (chlorine) and Br (bromine). Sb₂O₃ is preferably used as the clarifying agent. When the above clarifying agents exist alone or in combination, the upper limit of the content of the clarifying agent is preferably 1%, more preferably 0.5%. In some embodiments, the content of one or more of the above clarifying agents is about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9% and 2%.

PbO and As₂O₃ are toxic substances, and even a small amount of PbO and As₂O₃ do not meet the environmental protection requirements. Therefore, the present invention preferably comprises 0% of PbO and As₂O₃ in some embodiments.

In some embodiments of the present invention, the matrix glass, microcrystalline glass or microcrystalline glass product with colors can be prepared by comprising colorant, so as to make the matrix glass, microcrystalline glass or microcrystalline glass product show different colors, and the colorant comprises: 0-4% of NiO; and/or 0-4% of Ni₂O₃; and/or 0-2% of COO; and/or 0-2% of Co₂O₃; and/or 0-7% of Fe₂O₃; and/or 0-4% of MnO₂; and/or 0-8% of Er₂O₃; and/or 0-8% of Nd₂O₃; and/or 0-4% of Cu₂O; and/or 0-8% of Pr₂O₅; and/or 0-4% of CeO₂. The weight percentage content and role of the colorant thereof are detailed as follows:

Brown or green matrix glass, microcrystalline glass or microcrystalline glass product prepared by the present invention use NiO, Ni₂O₃ or Pr₂O₅ as the colorant. NiO and Ni₂O₃, as the colorant, are used to prepare the brown or green matrix glass, microcrystalline glass or microcrystalline glass product. Such two components can be used alone or mixed, and their respective content is generally below 4%, preferably below 3%. If the content exceeds 4%, the colorant cannot be well dissolved in the matrix glass, microcrystalline glass or microcrystalline glass product. The lower limit of their respective content is above 0.1%. If the content is less than 0.1%, the color of the matrix glass, microcrystalline glass or microcrystalline glass product is not obvious. In some embodiments, it can comprise about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9% and 4.0% of NiO or Ni₂O₃. If mixed for use, the total content of NiO and Ni₂O₃ is generally below 4%, and the lower limit of the total content is above 0.1%. In some embodiments, it can comprise about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9% and 4.0% of NiO or Ni₂O₃. Pr₂O₅ is used as the colorant of the green matrix glass, microcrystalline glass or microcrystalline glass product. If used alone, the content is generally below 8%, preferably below 6%, and the lower limit of Pr₂O₅ content is above 0.4%. If it is less than 0.4%, the color of the matrix glass, microcrystalline glass or microcrystalline glass product is not obvious. In some embodiments, it can comprise about 0.4%, 0.6%, 0.8%, 1.0%, 1.2%, 1.4%, 1.6%, 1.8%, 2.0%, 2.2%, 2.4%, 2.6%, 2.8%, 3.0%, 3.2%, 3.4%, 3.6%, 3.8%, 4.0%, 4.2%, 4.4%, 4.6%, 4.8%, 5.0%, 5.2%, 5.4%, 5.6%, 5.8%, 6.0%, 6.2%, 6.4%, 6.6%, 6.8%, 7.0%, 7.2%, 7.4%, 7.6%, 7.8% and 8.0% of Pr₂O₅.

Blue matrix glass, microcrystalline glass or microcrystalline glass product prepared by the present invention uses CoO or Co₂O₃ as the colorant. Such two colorant components can be used alone or mixed, and their respective content is generally below 2%, preferably below 1.8%. If the content exceeds 2%, the colorant cannot be well dissolved in the matrix glass, microcrystalline glass or microcrystalline glass product. The lower limit of their respective content is above 0.05%. If the content is less than 0.05%, the color of the matrix glass, microcrystalline glass or microcrystalline glass product is not obvious. In some embodiments, it can comprise about 0.05%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9% and 2.0% of CoO or Co₂O₃. If mixed for use, the total content of CoO and Co₂O₃ is no more than 2%, and the lower limit of the total content is above 0.05%. In some embodiments, it can comprise about 0.05%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9% and 2.0% of CoO and Co₂O₃.

Yellow matrix glass, microcrystalline glass or microcrystalline glass product prepared by the present invention uses Cu₂O or CeO₂ as the colorant. Such two colorant components can be used alone or mixed, and the lower limit of their respective content is above 0.5%. If the content is less than 0.5%, the color of the matrix glass, microcrystalline glass or microcrystalline glass product is not obvious. If used alone, Cu₂O is below 4%, preferably below 3%. If the content exceeds 4%, the matrix glass is prone to devitrification. In some embodiments, it can comprise about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9% and 4.0% of Cu₂O. If used alone, the content of CeO₂ is generally below 4%, preferably below 3%. If the content exceeds 4%, gloss of the matrix glass, microcrystalline glass or microcrystalline glass product is not good. In some embodiments, it can comprise about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9% and 4.0% of CeO₂. Meanwhile, adding a small amount of CeO₂ into the glass has the effect of defoaming. CeO₂ in the glass can also be used as the clarifying agent. When it is used as the clarifying agent, the content of CeO₂ is below 2%, preferably below 1%, more preferably below 0.5%. If two colorants are mixed for use, the total content thereof is generally below 4%, and the lower limit of the total content is above 0.5%. In some embodiments, it can comprise about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9% and 4.0% of CeO₂ and Cu₂O.

Black or smoky gray matrix glass, microcrystalline glass or microcrystalline glass product prepared by the present invention uses Fe₂O₃ alone as the colorant; or uses a mixture of Fe₂O₃ and CoO as the colorant; or uses a mixture of Fe₂O₃ and Co₂O₃ as the colorant; or uses a mixture of Fe₂O₃, CoO and NiO as the colorant; or uses a mixture of Fe₂O₃, Co₂O₃, and NiO as the colorant. The colorant used to prepare black and smoky gray matrix glass, microcrystalline glass or microcrystalline glass product mainly uses Fe₂O₃, and the content is below 7%, preferably below 5%. The lower limit of the content of Fe₂O₃ is above 0.2%. In some embodiments, it can comprise about 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.5%, 5.0%, 5.5%, 6.0%, 6.5% and 7.0% of Fe₂O₃. CoO and Co₂O₃ have absorption in visible light, which can deepen the coloring degree of the matrix glass, microcrystalline glass or microcrystalline glass product. In general, the respective content is below 0.6% when mixed with Fe₂O₃ for use, and the lower limit is above 0.2%. In some embodiments, it can comprise about 0.2%, 0.3%, 0.4%, 0.5%, and 0.6% of CoO and/or Co₂O₃. NiO has absorption in visible light, which can deepen the coloring degree of the matrix glass, microcrystalline glass or microcrystalline glass product. In general, the content of NiO is below 1% when mixed for use, and the lower limit of the total content is above 0.2%. In some embodiments, it can comprise about 0.2%, 0.3%, 0.4%, 0.5%, 0.6%, 0.7%, 0.8%, 0.9%, and 1.0% of NiO.

Purple matrix glass, microcrystalline glass or microcrystalline glass product prepared by the present invention uses MnO₂ as the colorant, and the use content is generally below 4%, preferably below 3%. The lower limit of MnO₂ content is above 0.1%. If it is less than 0.1%, the color of the matrix glass, microcrystalline glass or microcrystalline glass product is not obvious. In some embodiments, it can comprise about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, and 4.0% of MnO₂.

Pink matrix glass, microcrystalline glass or microcrystalline glass product prepared by the present invention uses Er₂O₃ as the colorant, and the use content is generally below 8%, preferably below 6%. Due to low coloring efficiency of rare earth element Er₂O₃, when the use content exceeds 8%, it cannot further deepen the color of the matrix glass, microcrystalline glass or microcrystalline glass product, but increase the cost. The lower limit of Er₂O₃ content is above 0.4%. If it is less than 0.4%, the color of the matrix glass, microcrystalline glass or microcrystalline glass product is not obvious. In some embodiments, it can comprise about 0.4%, 0.6%, 0.8%, 1.0%, 1.2%, 1.4%, 1.6%, 1.8%, 2.0%, 2.2%, 2.4%, 2.6%, 2.8%, 3.0%, 3.2%, 3.4%, 3.6%, 3.8%, 4.0%, 4.2%, 4.4%, 4.6%, 4.8%, 5.0%, 5.2%, 5.4%, 5.6%, 5.8%, 6.0%, 6.2%, 6.4%, 6.6%, 6.8%, 7.0%, 7.2%, 7.4%, 7.6%, 7.8%, and 8.0% of Er₂O₃.

Purplish red matrix glass, microcrystalline glass or microcrystalline glass product prepared by the present invention uses Nd₂O₃ as the colorant, and the use content is generally below 8%, preferably below 6%. Due to low coloring efficiency of rare earth element Nd₂O₃, when the use content exceeds 8%, it cannot further deepen the color of the matrix glass, microcrystalline glass or microcrystalline glass product, but increase the cost. The lower limit of Nd₂O₃ content is above 0.4%. If it is less than 0.4%, the color of the matrix glass, microcrystalline glass or microcrystalline glass product is not obvious. In some embodiments, it can comprise about 0.4%, 0.6%, 0.8%, 1.0%, 1.2%, 1.4%, 1.6%, 1.8%, 2.0%, 2.2%, 2.4%, 2.6%, 2.8%, 3.0%, 3.2%, 3.4%, 3.6%, 3.8%, 4.0%, 4.2%, 4.4%, 4.6%, 4.8%, 5.0%, 5.2%, 5.4%, 5.6%, 5.8%, 6.0%, 6.2%, 6.4%, 6.6%, 6.8%, 7.0%, 7.2%, 7.4%, 7.6%, 7.8%, and 8.0% of Nd₂O₃.

Red matrix glass, microcrystalline glass or microcrystalline glass product prepared by the present invention uses a mixture of Er₂O₃, Nd₂O₃ and MnO₂ as the colorant. In the glass, Er ion has absorption at 400-500 nm, Mn ion mainly has absorption at 500 nm, and Nd ion mainly has strong absorption at 580 nm, and the mixture of such three substances can prepare red matrix glass, microcrystalline glass or microcrystalline glass product. Since Er₂O₃ and Nd₂O₃ belong to rare earth coloring, the coloring capability is relatively weak. The usage amount of Er₂O₃ is within 6%, the usage amount of Nd₂O₃ is within 4%, and the usage amount of MnO₂ with strong coloring capability is within a range of 2%. The lower limit of the total mixed colorant content is above 0.9%.

The terms “not contained” and “0%” as used herein mean that the compound, molecule or element and the like are not intentionally added to the matrix glass, microcrystalline glass or microcrystalline glass product provided by the present invention as raw materials; however, as raw materials and/or equipment for the production of matrix glass, microcrystalline glass or microcrystalline glass product, there will be some impurities or components that are not intentionally added in small or trace amounts in the final matrix glass, microcrystalline glass or microcrystalline glass product, and this situation also falls within the protection scope of the present invention patent.

In some embodiments of the present invention, the crystalline phase in the microcrystalline glass and microcrystalline glass product comprises lithium monosilicate, which provides high strength for the microcrystalline glass and microcrystalline glass product provided by the present invention, and the fracture toughness of the microcrystalline glass and microcrystalline glass product becomes high; the body falling ball height of the microcrystalline glass and the falling ball test height and four-point bending strength of the microcrystalline glass product become larger. The microcrystalline glass provided by the present invention has excellent chemical strengthening performance, and can be subject to chemical strengthening process treatment in order to obtain excellent mechanical strength. Through rational component design, the microcrystalline glass and microcrystalline glass product provided by the present invention can obtain appropriate grain size, so that the microcrystalline glass and microcrystalline glass product provided by the present invention have high strength. The microcrystalline glass and microcrystalline glass product in the present invention have good crystallinity, so that the microcrystalline glass and microcrystalline glass product provided by the present invention have excellent mechanical performance. Crystallinity herein refers to the degree of crystal integrity. The internal particle arrangement of the crystal with complete crystallization is relatively regular, diffraction line is strong, sharp and symmetrical, and full width at half maximum of diffraction peak is close to the width measured by the instrument; defects like dislocation exist in the crystal with poor crystallinity, which makes the diffraction peaks wide and diffuse. The poorer the crystallinity, the weaker the diffraction capability, and the wider the diffraction peak until it disappears into the background. In some embodiments, the crystallinity of the microcrystalline glass product or microcrystalline glass is above 10%, preferably above 15%, more preferably above 20%.

The grain size and crystalline phase type in the microcrystalline glass or microcrystalline glass product provided by the present invention will affect the haze and light transmittance of the microcrystalline glass or microcrystalline glass product. The smaller the grain size, the higher the light transmittance; the smaller the haze, and the higher the light transmittance. In some embodiments, the haze of the microcrystalline glass product or microcrystalline glass with a thickness of below 1 mm is below 0.2%, preferably below 0.17%, more preferably below 0.15%. In some embodiments, the grain size of the microcrystalline glass product or microcrystalline glass is below 50 nm, preferably below 40 nm, more preferably below 30 nm.

In some embodiments, the content of crystalline phase and refractive index in the microcrystalline glass or microcrystalline glass product provided by the present invention affects the |B| value in the microcrystalline glass or microcrystalline glass product. Bluish or yellowish color is observed in the microcrystalline glass or microcrystalline glass product in the visible light range, which affects the optical performance of the product, and it is marked with |B| value in LAB (chromaticity value of substance color). The microcrystalline glass or microcrystalline glass product provided by the present invention shows low |B| value in the visible light range. In some embodiments, the average light |B| value at 400-800 nm of the microcrystalline glass product or microcrystalline glass with a thickness of below 1 mm is below 1.0, preferably below 0.9, more preferably below 0.8.

In some embodiments, the microcrystalline glass or microcrystalline glass product provided by the present invention shows high transparency in the visible light range (that is, the microcrystalline glass or microcrystalline glass product is transparent). The microcrystalline glass or microcrystalline glass product shows high transmittance in the visible light range. In some embodiments, the average light transmittance at 400-800 nm of the microcrystalline glass product or microcrystalline glass with a thickness of below 1 mm is preferably above 90.5%. In some preferred embodiments, the light transmittance at 550 nm of the microcrystalline glass product or microcrystalline glass with a thickness of below 1 mm is preferably above 91.5%.

In some embodiments, antimicrobial component can be added into the matrix glass, microcrystalline glass or microcrystalline glass product. The microcrystalline glass or microcrystalline glass product mentioned herein can be used in applications such as kitchen or catering countertops, where there is a high risk of exposure to harmful bacteria. The antimicrobial component contained in the matrix glass, microcrystalline glass or microcrystalline glass product includes, but is not limited to, Ag, AgO, Cu, CuO, and Cu₂O. In some embodiments, the content of the above-mentioned antimicrobial component alone or in combination is below 2%, preferably below 1%.

The matrix glass, microcrystalline glass and microcrystalline glass product provided by the present invention can be produced and manufactured by the following methods:

Formation of matrix glass: mixing raw materials uniformly according to the proportion of components, placing the uniformly mixed raw materials into a crucible made of platinum or quartz, melting in an electric furnace or gas furnace within a temperature range of 1250-1650° C. for 5-24 hours according to the melting difficulty of glass composition, stirring to make it uniform, then cooling to an appropriate temperature and casting into a mould, and cooling it slowly to form the matrix glass.

The matrix glass provided by the present invention can be formed by a well-known method.

The matrix glass provided by the present invention is subject to crystallization treatment through crystallization process after molding or molding processing, and crystals are uniformly precipitated inside the glass. The crystallization treatment can be carried out through one stage or two stages, preferably two stages. Perform nucleation process treatment under a first temperature, and then perform crystal growth process treatment under a second temperature that is higher than the nucleation process temperature. The crystallization treatment under the first temperature is called first crystallization treatment, and the crystallization treatment under the second temperature is called second crystallization treatment.

In order to make the microcrystalline glass achieve the desired physico-chemical performance, the crystallization process is preferably as follows:

When the above crystallization treatment is made through one stage, the nucleation process and crystal growth process can be carried out continuously. That is, heating up to a specified crystallization treatment temperature, holding the temperature for a certain time after reaching the crystallization treatment temperature, and then performing cooling. The crystallization treatment temperature is preferably 550-700° C. In order to precipitate the desired crystalline phase, the crystallization treatment temperature is more preferably 580-650° C. The holding time under the crystallization treatment temperature is preferably 0-8 hours, more preferably 1-6 hours.

When the above crystallization treatment is made through two stages, the first temperature is preferably 450-550° C., and the second temperature is preferably 550-700° C. The holding time under the first temperature is preferably 0-24 hours, more preferably 2-15 hours. The holding time under the second temperature is preferably 0-10 hours, more preferably 0.5-6 hours.

The above holding time of 0 hour refers to that the temperature starts to cool down or rise again less than 1 minute after reaching such temperature.

In some embodiments, the matrix glass or microcrystalline glass mentioned herein can be made into a former by a variety of processes, the former includes but is not limited to sheet, and the processes include but are not limited to slit drawing, floating, rolling and other sheet forming processes known in the art. Or the matrix glass or microcrystalline glass can be formed by floating or rolling method known in the art. The former mentioned in the present invention further comprises lens, prism, etc.

For the matrix glass or microcrystalline glass provided by the present invention, methods such as grinding or polishing can be adopted to manufacture sheet-type glass former or microcrystalline glass former, but the method of manufacturing the glass former or microcrystalline glass former is not limited to these methods.

For the matrix glass or microcrystalline glass provided by the present invention, methods such as hot bending or pressing process can be adopted at a certain temperature to manufacture various shapes of glass former or microcrystalline glass former, but are not limited to these methods.

In some embodiments, hot bending process can be adopted to make the glass former or microcrystalline glass former. Said hot bending process refers to placing 2D or 2.5D glass or microcrystalline glass in a mould, performing heating and warm-up, pressing, pressure holding and cooling successively in a hot bending machine, in order to make a 3D curved glass former or microcrystalline glass former.

In some embodiments, the microcrystalline glass former has a 2.5D or 3D structure, that is, the microcrystalline glass former has a non-planar structure. “Non-planar structure” herein refers to that in a 2.5D or 3D shape, at least a portion of the microcrystalline glass former extends outward or along an angle to a plane defined by original and layout configuration of the 2D matrix glass. The 2.5D or 3D microcrystalline glass former formed by the matrix glass may have one or more raised or curved parts.

In some embodiments, combined with the characteristics such as growth of crystalline phase, transformation of crystalline phase in the microcrystalline glass, the manufacturing method of the microcrystalline glass former is a hot bending process method. To be specific, said method comprises precrystallization and thermal processing. The precrystallization mentioned in the present invention is to form the matrix glass into precrystallized glass by controlling the crystallization process, and the crystallinity of said precrystallized glass fails to reach the crystallinity required by the performance index of the target microcrystalline glass former. Then, the precrystallized glass is formed into the microcrystalline glass former by thermal processing.

In some embodiments, the manufacturing method of the microcrystalline glass former comprises the following steps:
1) performing a crystallization heat treatment process once for the matrix glass, comprising heating, heat preservation and nucleation, heating, heat preservation and crystallization, cooling to room temperature, and forming a precrystallized glass;
2) and thermally processing the precrystallized glass to obtain the microcrystalline glass former.

The crystallization heat treatment process mentioned in the present invention comprises nucleating the matrix glass at a certain temperature Tₕ and time tₕ, and then performing crystallization at a certain temperature T_{c} and time t_{c}, wherein the crystallinity of the obtained precrystallized glass fails to reach the crystallinity required by the performance index of the target microcrystalline glass former. The total content of principal crystalline phase (I_{c1}) in the crystallinity of the precrystallized glass is calculated by applying XRD test data and Rietveld full-spectrum fitting refinement method. Precrystallization of the present invention is a complete process from the perspective of process, comprising one step of nucleation process, crystallization process of one stage, two stages or three stages and above. It is a complete process from heating, heat preservation, and heating again to heat preservation . . . and then cooling to room temperature according to the process. Different from the primary crystallization and secondary crystallization . . . mentioned in some literatures or patents, the present invention is actually only the first-stage crystallization, the second-stage crystallization . . . in a complete crystallization process. The intermediate process is continuous, and there is no other heating and crystallization process after falling to room temperature.

The thermal processing mentioned in the present invention refers to thermal processing treatment of said precrystallized glass under certain conditions such as temperature, time, and pressure. Said thermal processing comprises more than one thermal processing, and said thermal processing includes but is not limited to pressing, bending or drawing the precrystallized glass under certain conditions such as temperature, time, and pressure. In the process of thermal processing, sometimes the former with complex shape cannot be completed by one thermal processing, and more than twice of thermal processing may be required.

In some embodiments, the manufacturing method of the microcrystalline glass former belongs to hot bending process. To be specific, in some embodiments, the manufacturing method of the microcrystalline glass former comprises the following steps:
1) Heating and warm-up: placing the matrix glass or precrystallized glass or microcrystalline glass into a mould, making the mould pass through each heating site in a hot bending machine successively and stay at each site for a certain time for heat preservation. The temperature of warm-up zone is 400-800° C., pressure is 0.01-0.05 MPa, and time is 40-200 s. In some embodiments, for the hot bending machine of 5 warm-up sites, the initial temperature rise is generally set steadily at about 500° C., the subsequent sites gradually increase the temperature, the temperature gradient between two adjacent sites gradually narrows from low temperature to high temperature, and temperature difference between the last warm-up site and the first pressing site is within a range of 20° C.
2) Pressing: transferring the mould to a molding site after warm-up, wherein the hot bending machine exerts a certain pressure on the mould, pressure range is 0.1-0.8 Mpa, temperature range of the molding site is 600-850° C., and molding time range is 40-200 s. The pressure is determined according to the factors such as glass thickness and radian.
3) Pressure holding and cooling: transferring the mould to a cooling site to cool down site by site. The cooling temperature range is controlled to be 750-500° C., the pressure is 0.01-0.05 Mpa, and the time is 40-200 s.

The microcrystalline glass former adopts hot bending process. In addition to controlling the appearance quality of ordinary high-alumina glass, it is also necessary to control the influence of crystal growth and development on the performance of microcrystalline glass during hot bending. For example, for 3D curved microcrystalline glass used for the housing of display devices or electronic devices, close attention should be paid to the light transmittance after hot bending, haze, |B| value, and uniformity.

The matrix glass, microcrystalline glass and microcrystalline glass product mentioned in the present invention may have any thickness that is reasonably useful.

The microcrystalline glass provided by the present invention can not only improve the mechanical characteristics through crystal precipitation, but also obtain better mechanical performance by forming a compressive stress layer, so as to make the microcrystalline glass product.

In some embodiments, the matrix glass or microcrystalline glass can be processed into sheets, and/or molded (e.g. hole punching, hot bending, etc.), polished and/or swept after setting, and then chemically strengthened by a chemical strengthening process.

The chemical strengthening mentioned in the present invention is ion exchange method. In the process of ion exchange, smaller metal ions in the matrix glass or microcrystalline glass are substituted or “exchanged” by larger metal ions with the same valence state near the matrix glass or microcrystalline glass. The substitution of smaller ions with larger ions can construct the compressive stress in the matrix glass or microcrystalline glass, so as to form the compressive stress layer.

In some embodiments, metal ions belong to monovalent alkali metal ions (such as Na⁺, K⁺, Rb⁺ and Cs⁺), and the ion exchange is carried out by immersing the matrix glass or microcrystalline glass in the salt bath of at least one molten salt containing larger metal ions. These larger metal ions are used to substitute the smaller metal ions in the matrix glass. Or other monovalent metal ions, such as Ag⁺, Tl⁺ and Cu⁺, can also be used to exchange monovalent ions. One or more ion exchange processes for chemical strengthening of matrix glass or microcrystalline glass may include but are not limited to: immersing in a single salt bath, or immersing in a plurality of salt baths with the same or different composition, and conducting washing and/or annealing between the immersions.

In some embodiments, the matrix glass or microcrystalline glass can have ion exchange by immersing in the salt bath of molten Na salt (e.g. NaNO₃) at the temperature of about 350° C.-470° C. for about 1-36 hours. The temperature range is preferably 380° C.-460° C., and the time range is preferably 2-24 hours. In this implementation, Na ion substitutes some Li ions in the matrix glass or microcrystalline glass, so as to form the surface compression layer and show high mechanical performance. In some embodiments, the ion exchange can be carried out by immersing the matrix glass or microcrystalline glass in the salt bath of molten K salt (e.g. KNO₃) at the temperature of about 360° C.-450° C. for 1-36 hours, and the time range is preferably 2-24 hours. In some embodiments, the matrix glass or microcrystalline glass can have ion exchange by immersing in the salt bath of molten K salt and Na salt at the temperature of about 360° C.-450° C. for 1-36 hours, and the time range is preferably 2-24 hours.

The following methods are adopted to test the performance indexes of the microcrystalline glass and/or microcrystalline glass product and/or matrix glass provided by the present invention:

### [Haze]

Use haze tester Minolta CM3600A, prepare samples below 1 mm, and test according to GB2410-80 standard.

### [Grain Size]

It is measured by SEM (scanning electron microscope). The grain size is determined by performing surface treatment of microcrystalline glass in HF acid, spraying gold on the surface of microcrystalline glass, and then scanning the surface under SEM (scanning electron microscope).

### [Light Transmittance]

The light transmittance mentioned herein is external transmittance, sometimes referred to as transmittance.

The average light transmittance at 400-800 nm is measured by processing the sample to be below 1 mm and polishing in parallel with the opposite plane, and using Hitachi U-41000 spectrophotometer.

The light transmittance at 550 nm is measured by processing the sample to be below 1 mm and polishing in parallel with the opposite plane, and using Hitachi U-41000 spectrophotometer.

### [Crystallinity]

XRD diffraction peaks are compared with database pattern. Crystallinity is obtained by calculating the proportion of crystalline phase diffraction intensity in the overall pattern intensity, and calibrating internally by using pure quartz crystals.

### [Depth of Ion Exchange Layer]

Use glass surface stress gauge SLP-2000 to measure the depth of ion exchange layer.

The calculation is made based on the refractive index of 1.56 and optical elastic constant of 29[(nm/cm)/Mpa] of the sample.

### [Surface Stress]

Use glass surface stress meter SLP-2000 to measure the surface stress.

The calculation is made based on the refractive index of 1.52 and optical elastic constant of 29[(nm/cm)/Mpa] of the sample.

### [Drop Resistance]

Use directional drop tester WH-2101 to test the drop resistance. Freely fall from a specified height after loading the same specification of glass products onto a 2D microcrystalline glass product (each piece weighs 20 g, with 2 pieces of loads) and laying 60-80 mesh sandpaper on a base, and hit the sample directly onto the sandpaper. The drop resistance refers to the height where no fracture occurs and the impact can be withstood. To be specific, the test starts from a height of 600 mm, and the height is changed successively by 700 mm, 800 mm, 900 mm, 1000 mm and above in case of no fracture. For the embodiments with “drop resistance”, the microcrystalline glass product is taken as the test object. The test data recorded as 2000 mm in the embodiment means that even when the microcrystalline glass product with load drops from the height of 2000 mm, no fracture occurs and the impact can be withstood. The maximum experimental height of the drop tester WH-2101 is 2000 mm.

### [Falling Ball Test Height]

Place a 145 mm×67 mm×0.7 mm microcrystalline glass product sample onto a glass bearing fixture, so that a 132 g steel ball falls from the specified height. The falling ball test height refers to the maximum falling ball test height where the sample has no fracture and the impact can be withstood. To be specific, the test starts from a falling ball test height of 800 mm, and the height is changed successively by 850 mm, 900 mm, 950 mm, 1000 mm and above in case of no fracture. For the embodiments with “falling ball test height”, the microcrystalline glass product is taken as the test object. The test data recorded as 1000 mm in the embodiment means that even when the steel ball drops from the height of 1000 mm, the microcrystalline glass product has no fracture and the impact is withstood. The falling ball test height in the present invention is sometimes referred to as falling ball height.

### [Body Falling Ball Height]

Place a 145 mm×67 mm×0.7 mm microcrystalline glass sample onto a glass bearing fixture, so that a 32 g steel ball falls from the specified height. The body falling ball height refers to the maximum falling ball test height where the sample has no fracture and the impact can be withstood. To be specific, the test starts from a falling ball test height of 500 mm, and the height is changed successively by 550 mm, 600 mm, 650 mm, 700 mm and above in case of no fracture. For the embodiments with “body falling ball height”, the microcrystalline glass is taken as the test object, i.e., the falling ball test height of the microcrystalline glass. The test data recorded as 1000 mm in the embodiment means that even when the steel ball drops from the height of 1000 mm, the microcrystalline glass has no fracture and the impact is withstood.

### [Fracture Toughness]

Directly measure the indentation expansion crack size. The specimen specification is 2 mm×4 mm×20 mm. After the specimen is prepared by chamfering, grinding and polishing, apply a 49N force onto the specimen with a Vickers hardness indenter and maintain it for 30 s until indentation appears, and then measure the fracture strength by a three-point bending method.

### [Four-Point Bending Strength]

Use microcomputer-controlled electronic universal testing machine CMT6502 to test the sample with thickness of below 1 mm in accordance with ASTM C 158-2002. Four-point bending strength is sometimes referred to as bending strength in the present invention.

### [Vickers Hardness]

It is expressed by the load (N) when a diamond quadrangular indenter with an opposite plane angle of 1360 is pressed into a pyramid-shaped depression on the test surface divided by the surface area (mm²) calculated by the length of the depression. The test load is 100(N), and the holding time is 15 (seconds). Vickers hardness is sometimes referred to as hardness in the present invention.

### [|B| Value]

Use Minolta CM-700d to test the B value. The thickness of the sample is below 1 mm. Use supporting long calibration tube and short calibration tube to calibrate the instrument zero and whiteboard respectively, then perform an air test with the long tube, and judge the stability and reliability of instrument calibration (B≤0.05). After the instrument calibration is qualified, place a product on the zero-position long tube for testing.

|B| value is the absolute value of B.

### [Young's Modulus]

The Young's modulus (E) is tested by ultrasonic wave for P-wave velocity and S-wave velocity, and then calculated according to the following formula.

$$E = \frac{4 {G}^{2} - 3 {GV}_{T}^{2} ρ}{G - {V}_{T}^{2} ρ}$$

Wherein:
E refers to Young's modulus, Pa;
G refers to shear modulus, Pa;
V_{T} refers to S-wave velocity, m/s;
V_{S} refers to P-wave velocity, m/s;
ρ refers to glass density, g/cm³.

### [Refractive Index]

The refractive index (n_{d}) is tested as per the method specified in GB T7962.1-2010.

The microcrystalline glass product provided by the present invention has the properties as below:
1) In some embodiments, the four-point bending strength of the microcrystalline glass product is above 600 MPa, preferably above 650 MPa, more preferably above 700 MPa.
2) In some embodiments, the depth of the ion exchange layer of the microcrystalline glass product is above 80 μm, preferably above 90 μm, more preferably above 100 μm.
3) In some embodiments, the surface stress of the microcrystalline glass product is above 100 MPa, preferably above 150 MPa, more preferably above 200 MPa.
4) In some embodiments, the falling ball test height of the microcrystalline glass product is above 1400 mm, preferably above 1500 mm, more preferably above 1600 mm.
5) In some embodiments, the fracture toughness of the microcrystalline glass product is above 1 MPa·m^{1/2}, preferably above 1.1 MPa·m^{1/2}, more preferably above 1.2 MPa·m^{1/2}.
6) In some embodiments, the Vickers hardness (Hᵥ) of the microcrystalline glass product is above 670 kgf/mm², preferably above 680 kgf/mm², more preferably above 700 kgf/mm².
7) In some embodiments, the crystallinity of the microcrystalline glass product is above 10%, preferably above 15%, more preferably above 20%.
8) In some embodiments, the grain size of the microcrystalline glass product is below 50 nm, preferably below 40 nm, more preferably below 30 nm.
9) In some embodiments, the drop resistance of the microcrystalline glass product is above 1500 mm, preferably above 1600 mm, more preferably above 1800 mm.
10) In some embodiments, the haze of the microcrystalline glass product with a thickness of below 1 mm is below 0.2%, preferably below 0.17%, more preferably below 0.15%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
11) In some embodiments, the average light transmittance at 400-800 nm wavelength of the microcrystalline glass product with a thickness of below 1 mm is above 88.0%, preferably above 89.0%, more preferably above 90.0%, further preferably above 90.5%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
12) In some embodiments, the light transmittance at 550 nm wavelength of the microcrystalline glass product with a thickness of below 1 mm is above 89.0%, preferably above 90.0%, more preferably above 91.0%, further preferably above 91.5%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm. 13) In some embodiments, the average light |B| value at 400-800 nm of the microcrystalline glass product with a thickness of below 1 mm is below 1.0, preferably below 0.9, more preferably below 0.8. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.

The microcrystalline glass provided by the present invention has the properties as below:
1) In some embodiments, the crystallinity of the microcrystalline glass is above 10%, preferably above 15%, more preferably above 20%.
2) In some embodiments, the grain size of the microcrystalline glass is below 50 nm, preferably below 40 nm, more preferably below 30 nm.
3) In some embodiments, the haze of the microcrystalline glass with a thickness of below 1 mm is below 0.2%, preferably below 0.17%, more preferably below 0.15%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
4) In some embodiments, the average light transmittance at 400-800 nm wavelength of the microcrystalline glass with a thickness of below 1 mm is above 87.0%, preferably above 88.0%, more preferably above 88.5%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
5) In some embodiments, the light transmittance at 550 nm wavelength of the microcrystalline glass with a thickness of below 1 mm is above 89.0%, preferably above 90.0%, more preferably above 90.5%. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
6) In some embodiments, the body falling ball height of the microcrystalline glass is above 1700 mm, preferably above 1900 mm, more preferably above 2000 mm.
7) In some embodiments, the average light |B| value at 400-800 nm of the microcrystalline glass with a thickness of below 1 mm is below 1.0, preferably below 0.9, more preferably below 0.8. This thickness is preferably 0.2-1 mm, more preferably 0.3-0.9 mm, further preferably 0.5-0.8 mm, more further preferably 0.55 mm or 0.6 mm or 0.68 mm or 0.7 mm or 0.75 mm.
8) In some embodiments, the Vickers hardness (Hᵥ) of the microcrystalline glass is above 600 kgf/mm², preferably above 620 kgf/mm², more preferably above 630 kgf/mm².
9) In some embodiments, the refractive index (n_{d}) of the microcrystalline glass is 1.520-1.545.
10) In some embodiments, the Young's modulus (E) of the microcrystalline glass product is 80-100 GPa.

The matrix glass provided by the present invention has the properties as below:

### 1) in Some Embodiments, the Refractive Index (n_{d}) of the Matrix Glass is 1.510-1.530.

Due to the above-mentioned excellent performance, the microcrystalline glass, microcrystalline glass product, matrix glass, glass former, and microcrystalline glass former provided by the present invention can be widely made into glass cover plates or glass components; meanwhile, the microcrystalline glass, microcrystalline glass product, matrix glass, glass former, and microcrystalline glass former provided by the present invention can be applied in electronic devices or display devices, such as mobile phone, watch, computer, and touch screen, and can be used to manufacture protective glass for mobile phone, smart phone, tablet, laptop, PDA, television, personal computer, MTA machine or industrial display, or can be used to manufacture touch screen, protective window, car window, train window, aviation mechanical window, and protective glass of touch screen, or can be used to manufacture hard disk substrate or solar cell substrate, or can be used to manufacture white household appliances, such as refrigerator parts or kitchenware.

### Examples

The following non-limiting examples are provided in order to further clearly explain and illustrate the technical solution of the present invention. Many efforts have been made to ensure the accuracy of numerical values (e.g., quantity, temperature) in the examples of the present invention, but some errors and deviations must be considered. The composition itself is given as wt % based on oxide and has been standardized to 10000.

### <Examples of Matrix Glass>

This example obtains the matrix glass with composition shown in Tables 1-2 by the above manufacturing method of matrix glass. In addition, the characteristics of each matrix glass are measured by the test method mentioned in the present invention, and the measurement results are shown in Tables 1-2.

TABLE 1

| Examples (wt %) | 1# | 2# | 3# | 4# | 5# | 6# | 7# | 8# | 9# | 10# |
|---|---|---|---|---|---|---|---|---|---|---|
| SiO₂ | 66 | 65 | 66.5 | 67 | 67.5 | 68 | 68.5 | 69 | 69.5 | 70 |
| Al₂O₃ | 9.3 | 9.7 | 9.5 | 6.5 | 5.5 | 9.5 | 9.5 | 8 | 5 | 6 |
| Li₂O | 9 | 8.8 | 9 | 9 | 9.2 | 8 | 7.5 | 7 | 7 | 7 |
| ZrO₂ | 7 | 8.4 | 6.7 | 8.5 | 9.5 | 5.5 | 7 | 6 | 12 | 7.5 |
| Na₂O | 5.5 | 5 | 5.2 | 6 | 5 | 6 | 4.5 | 6.5 | 5.5 | 7 |
| K₂O | 0 | 0 | 0 | 0.5 | 1 | 0 | 0 | 0 | 0 | 0 |
| P₂O₅ | 2 | 1.8 | 1.9 | 2 | 1.8 | 2.5 | 3 | 3.5 | 0 | 2 |
| ZnO | 0.2 | 0.3 | 0.2 | 0 | 0.2 | 0 | 0 | 0 | 0 | 0.5 |
| MgO | 0.5 | 0.5 | 0.45 | 0 | 0 | 0.2 | 0 | 0 | 0 | 0 |
| B₂O₃ | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0.5 | 0.5 | 0.55 | 0.5 | 0.3 | 0.3 | 0 | 0 | 0 | 0 |
| In total | 100 | 100 | 100 | 100 | 100 | 100 | 100 | 100 | 100 | 100 |
| SiO₂/ZrO₂ | 9.4 | 7.7 | 9.9 | 7.9 | 7.1 | 12.4 | 9.8 | 11.5 | 5.8 | 9.3 |
| (SiO₂ + Li₂O)/(ZrO₂ + | 8.3 | 7.2 | 8.8 | 7.2 | 6.8 | 9.5 | 7.6 | 8.0 | 6.4 | 8.1 |
| P₂O₅) | | | | | | | | | | |
| (SiO₂ + Al₂O₃ + | 9.0 | 9.1 | 9.0 | 8.8 | 8.5 | 10.4 | 11.0 | 11.9 | 11.6 | 11.9 |
| Na₂O)/Li₂O | | | | | | | | | | |
| (ZrO₂ + Al₂O₃)/Li₂O | 1.8 | 2.1 | 1.8 | 1.7 | 1.6 | 1.9 | 2.2 | 2.0 | 2.4 | 1.9 |
| (Li₂O + Na₂O)/(SiO₂ + | 0.20 | 0.19 | 0.19 | 0.20 | 0.18 | 0.19 | 0.16 | 0.18 | 0.17 | 0.18 |
| ZrO₂) | | | | | | | | | | |
| Refractive index | 1.5199 | 1.5187 | 1.5206 | 1.5193 | 1.5213 | 1.5219 | 1.5209 | 1.5215 | 1.5206 | 1.5248 |

TABLE 2

| Examples (wt %) | 11# | 12# | 13# | 14# | 15# | 16# | 17# | 18# | 19# | 20# |
|---|---|---|---|---|---|---|---|---|---|---|
| SiO₂ | 70.5 | 71 | 71.5 | 64 | 63 | 62 | 72 | 73 | 74 | 75 |
| Al₂O₃ | 8 | 6 | 10 | 9 | 8 | 8 | 6 | 6 | 6 | 6 |
| Li₂O | 8.5 | 7.5 | 8 | 8.5 | 9 | 5.5 | 7 | 7 | 7 | 6.5 |
| ZrO₂ | 6 | 6 | 6 | 9 | 12 | 12 | 7 | 7 | 6.5 | 6.5 |
| Na₂O | 5 | 5.5 | 4.5 | 5.5 | 4 | 8 | 4.5 | 4.5 | 4.5 | 4.5 |
| K₂O | 0 | 0 | 0 | 0 | 0 | 0 | 0.5 | 0 | 0 | 0 |
| P₂O₅ | 2 | 4 | 0 | 2 | 0 | 0 | 2 | 2 | 2 | 1.5 |
| ZnO | 0 | 0 | 0 | 1 | 0 | 2 | 0 | 0.5 | 0 | 0 |
| MgO | 0 | 0 | 0 | 1 | 2 | 0 | 0.5 | 0 | 0 | 0 |
| B₂O₃ | 0 | 0 | 0 | 0 | 2 | 2.5 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0.5 | 0 | 0 | 0 |
| In total | 100 | 100 | 100 | 100 | 100 | 100 | 100 | 100 | 100 | 100 |
| SiO₂/ZrO₂ | 11.8 | 11.8 | 11.9 | 7.1 | 5.3 | 5.2 | 10.3 | 10.4 | 11.4 | 11.5 |
| (SiO₂ + Li₂O)/(ZrO₂ + | 9.9 | 7.9 | 13.3 | 6.6 | 6.0 | 5.6 | 8.8 | 8.9 | 9.5 | 10.2 |
| P₂O₅) | | | | | | | | | | |
| (SiO₂ + Al₂O₃ + | 9.8 | 11.0 | 10.8 | 9.2 | 8.3 | 14.2 | 11.8 | 11.9 | 12.1 | 13.2 |
| Na₂O)/Li₂O | | | | | | | | | | |
| (ZrO₂ + Al₂O₃)/Li₂O | 1.6 | 1.6 | 2.0 | 2.1 | 2.2 | 3.6 | 1.9 | 1.9 | 1.8 | 1.9 |
| (Li₂O + Na₂O)/(SiO₂ + | 0.18 | 0.17 | 0.16 | 0.19 | 0.17 | 0.18 | 0.15 | 0.14 | 0.14 | 0.13 |
| ZrO₂) | | | | | | | | | | |
| Refractive index | 1.5233 | 1.5219 | 1.5239 | 1.5242 | 1.5237 | 1.5201 | 1.5222 | 1.5215 | 1.5212 | 1.5227 |

### <Examples of Microcrystalline Glass>

This example obtains the microcrystalline glass with composition shown in Tables 3-4 by the above manufacturing method of microcrystalline glass. In addition, the characteristics of each microcrystalline glass are measured by the test method mentioned in the present invention, and the measurement results are shown in Tables 3-4. The following embodiments show haze, average light transmittance at 400-800 nm wavelength, light transmittance at 550 nm wavelength, and average light |B| value at 400-800 nm, and the thickness of the test sample is 0.7 mm.

TABLE 3

| Examples (wt %) | 1# | 2# | 3# | 4# | 5# | 6# | 7# | 8# | 9# | 10# |
|---|---|---|---|---|---|---|---|---|---|---|
| SiO₂ | 66 | 65 | 66.5 | 67 | 67.5 | 68 | 68.5 | 69 | 69.5 | 70 |
| Al₂O₃ | 9.3 | 9.7 | 9.5 | 6.5 | 5.5 | 9.5 | 9.5 | 8 | 5 | 6 |
| Li₂O | 9 | 8.8 | 9 | 9 | 9.2 | 8 | 7.5 | 7 | 7 | 7 |
| ZrO₂ | 7 | 8.4 | 6.7 | 8.5 | 9.5 | 5.5 | 7 | 6 | 12 | 7.5 |
| Na₂O | 5.5 | 5 | 5.2 | 6 | 5 | 6 | 4.5 | 6.5 | 6.5 | 7 |
| K₂O | 0 | 0 | 0 | 0.5 | 1 | 0 | 0 | 0 | 0 | 0 |
| P₂O₅ | 2 | 1.8 | 1.9 | 2 | 1.8 | 2.5 | 3 | 3.5 | 0 | 2 |
| ZnO | 0.2 | 0.3 | 0.2 | 0 | 0.2 | 0 | 0 | 0 | 0 | 0.5 |
| MgO | 0.5 | 0.5 | 0.45 | 0 | 0 | 0.2 | 0 | 0 | 0 | 0 |
| B₂O₃ | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0.5 | 0.5 | 0.55 | 0.5 | 0.3 | 0.3 | 0 | 0 | 0 | 0 |
| In total | 100 | 100 | 100 | 100 | 100 | 100 | 100 | 100 | 100 | 100 |
| SiO₂/ZrO₂ | 9.4 | 7.7 | 9.9 | 7.9 | 7.1 | 12.4 | 9.8 | 11.5 | 5.8 | 9.3 |
| (SiO₂ + Li₂O)/(ZrO₂ + | 8.3 | 7.2 | 8.8 | 7.2 | 6.8 | 9.5 | 7.6 | 8.0 | 6.4 | 8.1 |
| P₂O₅) | | | | | | | | | | |
| (SiO₂ + Al₂O₃ + | 9.0 | 9.1 | 9.0 | 8.8 | 8.5 | 10.4 | 11.0 | 11.9 | 11.6 | 11.9 |
| Na₂O)/Li₂O | | | | | | | | | | |
| (ZrO₂ + Al₂O₃)/Li₂O | 1.8 | 2.1 | 1.8 | 1.7 | 1.6 | 1.9 | 2.2 | 2.0 | 2.4 | 1.9 |
| (Li₂O + Na₂O)/(SiO₂ + | 0.20 | 0.19 | 0.19 | 0.20 | 0.18 | 0.19 | 0.16 | 0.18 | 0.17 | 0.18 |
| ZrO₂) | | | | | | | | | | |
| Crystalline | Lithium | Lithium | Lithium | Lithium | Lithium | Lithium | Lithium | Lithium | Lithium | Lithium |
| phase | monosil- | monosil- | monosil- | monosil- | monosil- | monosil- | monosil- | monosil- | monosil- | monosil- |
| | icate | icate | icate | icate | icate | icate | icate | icate | icate | icate |
| Refractive index | 1.5339 | 1.5284 | 1.5341 | 1.5275 | 1.5308 | 1.5338 | 1.5305 | 1.5316 | 1.5328 | 1.5285 |
| Body falling | 1800 | 1800 | 1800 | 1800 | 1800 | 1700 | 1800 | 1800 | 1800 | 1800 |
| ball height (mm) | | | | | | | | | | |
| Crystallinity (%) | 25 | 28 | 23 | 30 | 23 | 25 | 28 | 26 | 23 | 25 |
| Grain size (nm) | 27 | 26 | 29 | 26 | 28 | 26 | 26 | 29 | 25 | 26 |
| Vickers | 642 | 646 | 641 | 636 | 643 | 635 | 648 | 652 | 656 | 657 |
| hardness | | | | | | | | | | |
| (kgf/mm²) | | | | | | | | | | |
| Haze (%) | 0.13 | 0.12 | 0.11 | 0.12 | 0.12 | 0.15 | 0.11 | 0.13 | 0.15 | 0.1 |
| \| B \| value | 0.77 | 0.75 | 0.7 | 0.72 | 0.78 | 0.85 | 0.75 | 0.73 | 0.88 | 0.73 |
| Average light | 91.5 | 91.5 | 91.5 | 91.5 | 91.5 | 90.0 | 91.5 | 91.5 | 89.0 | 91.0 |
| transmittance at | | | | | | | | | | |
| 400-800 nm (%) | | | | | | | | | | |
| Light | 92.0 | 92.0 | 92.0 | 92.0 | 92.0 | 92.0 | 92.0 | 92.0 | 91.5 | 92.0 |
| transmittance | | | | | | | | | | |
| at 550 nm | | | | | | | | | | |
| wavelength (%) | | | | | | | | | | |
| Young's | 85 | 87 | 83 | 88 | 95 | 93 | 92 | 87 | 90 | 88 |
| modulus (GPa) | | | | | | | | | | |

TABLE 4

| Examples (wt %) | 11# | 12# | 13# | 14# | 15# | 16# | 17# | 18# | 19# | 20# |
|---|---|---|---|---|---|---|---|---|---|---|
| SiO₂ | 70.5 | 71 | 71.5 | 64 | 63 | 62 | 72 | 73 | 74 | 75 |
| Al₂O₃ | 8 | 6 | 10 | 9 | 8 | 8 | 6 | 6 | 6 | 6 |
| Li₂O | 8.5 | 7.5 | 8 | 8.5 | 9 | 5.5 | 7 | 7 | 7 | 6.5 |
| ZrO₂ | 6 | 6 | 6 | 9 | 12 | 12 | 7 | 7 | 6.5 | 6.5 |
| Na₂O | 5 | 5.5 | 4.5 | 5.5 | 4 | 8 | 4.5 | 4.5 | 4.5 | 4.5 |
| K₂O | 0 | 0 | 0 | 0 | 0 | 0 | 0.5 | 0 | 0 | 0 |
| P₂O₅ | 2 | 4 | 0 | 2 | 0 | 0 | 2 | 2 | 2 | 1.5 |
| ZnO | 0 | 0 | 0 | 1 | 0 | 2 | 0 | 0.5 | 0 | 0 |
| MgO | 0 | 0 | 0 | 1 | 2 | 0 | 0.5 | 0 | 0 | 0 |
| B₂O₃ | 0 | 0 | 0 | 0 | 2 | 2.5 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0.5 | 0 | 0 | 0 |
| In total | 100 | 100 | 100 | 100 | 100 | 100 | 100 | 100 | 100 | 100 |
| SiO₂/ZrO₂ | 11.8 | 11.8 | 11.9 | 7.1 | 5.3 | 5.2 | 10.3 | 10.4 | 11.4 | 11.5 |
| (SiO₂ + Li₂O)/(ZrO₂ + | 9.9 | 7.9 | 13.3 | 6.6 | 6.0 | 5.6 | 8.8 | 8.9 | 9.5 | 10.2 |
| P₂O₅) | | | | | | | | | | |
| (SiO₂ + Al₂O₃ + | 9.8 | 11.0 | 10.8 | 9.2 | 8.3 | 14.2 | 11.8 | 11.9 | 12.1 | 13.2 |
| Na₂O)/Li₂O | | | | | | | | | | |
| (ZrO₂ + Al₂O₃)/Li₂O | 1.6 | 1.6 | 2.0 | 2.1 | 2.2 | 3.6 | 1.9 | 1.9 | 1.8 | 1.9 |
| (Li₂O + Na₂O)/(SiO₂ + | 0.18 | 0.17 | 0.16 | 0.19 | 0.17 | 0.18 | 0.15 | 0.14 | 0.14 | 0.13 |
| ZrO₂) | | | | | | | | | | |
| Crystalline phase | Lithium | Lithium | Lithium | Lithium | Lithium | Lithium | Lithium | Lithium | Lithium | Lithium |
| | monosili- | monosili- | monosili- | monosili- | monosili- | monosili- | monosili- | monosili- | monosili- | monosili- |
| | cate | cate | cate | cate | cate | cate | cate | cate | cate | cate |
| Refractive index | 1.5275 | 1.5299 | 1.5328 | 1.5288 | 1.5272 | 1.5276 | 1.5305 | 1.5275 | 1.536 | 1.5332 |
| Body falling ball | 1700 | 1800 | 1800 | 1800 | 1800 | 1900 | 1800 | 1800 | 1800 | 1800 |
| height (mm) | | | | | | | | | | |
| Crystallinity (%) | 24 | 27 | 18 | 21 | 23 | 25 | 13 | 21 | 25 | 23 |
| Grain size (nm) | 27 | 28 | 26 | 27 | 35 | 40 | 25 | 28 | 27 | 35 |
| Vickers hardness | 643 | 646 | 647 | 638 | 649 | 653 | 633 | 638 | 633 | 623 |
| (kgf/mm²) | | | | | | | | | | |
| Haze (%) | 0.16 | 0.16 | 0.2 | 0.12 | 0.15 | 0.15 | 0.13 | 0.11 | 0.12 | 0.12 |
| \| B \| value | 0.88 | 0.85 | 0.87 | 0.73 | 0.82 | 0.83 | 0.68 | 0.64 | 0.67 | 0.78 |
| Average light | 90.0 | 90.5 | 90.5 | 91.0 | 89.0 | 90.0 | 90.5 | 91.0 | 90.5 | 91.0 |
| transmittance at | | | | | | | | | | |
| 400-800 nm (%) | | | | | | | | | | |
| Light | 92.0 | 92.0 | 92.0 | 92.0 | 91.5 | 92.0 | 92.0 | 92.0 | 92.0 | 92.0 |
| transmittance at | | | | | | | | | | |
| 550 nm | | | | | | | | | | |
| wavelength (%) | | | | | | | | | | |
| Young's modulus | 93 | 96 | 89 | 87 | 94 | 85 | 88 | 89 | 90 | 91 |
| (GPa) | | | | | | | | | | |

### <Examples of Microcrystalline Glass Product>

This example obtains the microcrystalline glass product with composition shown in Tables 5-6 by the above manufacturing method of microcrystalline glass product. In addition, the characteristics of each microcrystalline glass product are measured by the test method mentioned in the present invention, and the measurement results are shown in Tables 5-6. The following embodiments show haze, average light transmittance at 400-800 nm wavelength, light transmittance at 550 nm wavelength, and average light |B| value at 400-800 nm, and the thickness of the test sample is 0.7 mm.

TABLE 5

| Examples (wt %) | 1# | 2# | 3# | 4# | 5# | 6# | 7# | 8# | 9# | 10# |
|---|---|---|---|---|---|---|---|---|---|---|
| SiO₂ | 66 | 65 | 66.5 | 67 | 67.5 | 68 | 68.5 | 69 | 69.5 | 70 |
| Al₂O₃ | 9.3 | 9.7 | 9.5 | 6.5 | 5.5 | 9.5 | 9.5 | 8 | 5 | 6 |
| Li₂O | 9 | 8.8 | 9 | 9 | 9.2 | 8 | 7.5 | 7 | 7 | 7 |
| ZrO₂ | 7 | 8.4 | 6.7 | 8.5 | 9.5 | 5.5 | 7 | 6 | 12 | 7.5 |
| Na₂O | 5.5 | 5 | 5.2 | 6 | 5 | 6 | 4.5 | 6.5 | 6.5 | 7 |
| K₂O | 0 | 0 | 0 | 0.5 | 1 | 0 | 0 | 0 | 0 | 0 |
| P₂O₅ | 2 | 1.8 | 1.9 | 2 | 1.8 | 2.5 | 3 | 3.5 | 0 | 2 |
| ZnO | 0.2 | 0.3 | 0.2 | 0 | 0.2 | 0 | 0 | 0 | 0 | 0.5 |
| MgO | 0.5 | 0.5 | 0.45 | 0 | 0 | 0.2 | 0 | 0 | 0 | 0 |
| B₂O₃ | 0 | 0 | 0 | 0 | 0 | 0 | 0 | 0 | 0 | 0 |
| La₂O₃ | 0 | 0 | 0 | 0 | 0 | 0 | 0 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0.5 | 0.5 | 0.55 | 0.5 | 0.3 | 0.3 | 0 | 0 | 0 | 0 |
| In total | 100 | 100 | 100 | 100 | 100 | 100 | 100 | 100 | 100 | 100 |
| SiO₂/ZrO₂ | 9.4 | 7.7 | 9.9 | 7.9 | 7.1 | 12.4 | 9.8 | 11.5 | 5.8 | 9.3 |
| (SiO₂ + Li₂O)/(ZrO₂ + | 8.3 | 7.2 | 8.8 | 7.2 | 6.8 | 9.5 | 7.6 | 8.0 | 6.4 | 8.1 |
| P₂O₅) | | | | | | | | | | |
| (SiO₂ + Al₂O₃ + | 9.0 | 9.1 | 9.0 | 8.8 | 8.5 | 10.4 | 11.0 | 11.9 | 11.6 | 11.9 |
| Na₂O)/Li₂O | | | | | | | | | | |
| (ZrO₂ + Al₂O₃)/Li₂O | 1.8 | 2.1 | 1.8 | 1.7 | 1.6 | 1.9 | 2.2 | 2.0 | 2.4 | 1.9 |
| (Li₂O + Na₂O)/(SiO₂ + | 0.20 | 0.19 | 0.19 | 0.20 | 0.18 | 0.19 | 0.16 | 0.18 | 0.17 | 0.18 |
| ZrO₂) | | | | | | | | | | |
| Crystalline phase | Lithium | Lithium | Lithium | Lithium | Lithium | Lithium | Lithium | Lithium | Lithium | Lithium |
| | monosil- | monosil- | monosil- | monosil- | monosil- | monosil- | monosil- | monosil- | monosil- | monosil- |
| | icate | icate | icate | icate | icate | icate | icate | icate | icate | icate |
| Crystallinity (%) | 25 | 28 | 23 | 30 | 23 | 25 | 28 | 26 | 23 | 25 |
| Surface stress (MPa) | 226 | 236 | 269 | 248 | 225 | 205 | 278 | 271 | 250 | 215 |
| Depth of ion | 138 | 145 | 135 | 120 | 118 | 149 | 130 | 137 | 125 | 116 |
| exchange layer (μm) | | | | | | | | | | |
| Falling ball | 1600 | 1600 | 1700 | 1600 | 1600 | 1600 | 1600 | 1700 | 1600 | 1700 |
| test height (mm) | | | | | | | | | | |
| Drop resistance (mm) | 1800 | 2000 | 1900 | 1800 | 2000 | 1800 | 1900 | 1800 | 2000 | 1800 |
| Fracture toughness | 1.4 | 1.3 | 1.6 | 1.3 | 1.4 | 1.5 | 1.3 | 1.4 | 1.4 | 1.5 |
| (MPa · m^{1/2}) | | | | | | | | | | |
| Four-point bending | 712 | 715 | 752 | 710 | 718 | 705 | 708 | 718 | 724 | 723 |
| strength (MPa) | | | | | | | | | | |
| Grain size (nm) | 27 | 26 | 29 | 26 | 28 | 26 | 26 | 29 | 25 | 26 |
| Vickers hardness | 705 | 723 | 735 | 735 | 705 | 718 | 706 | 745 | 716 | 713 |
| (kgf/mm²) | | | | | | | | | | |
| Haze (%) | 0.13 | 0.12 | 0.11 | 0.12 | 0.12 | 0.15 | 0.11 | 0.13 | 0.15 | 0.1 |
| \| B \| value | 0.77 | 0.75 | 0.7 | 0.72 | 0.78 | 0.85 | 0.75 | 0.73 | 0.88 | 0.73 |
| Average light | 91.5 | 91.5 | 91.5 | 91.5 | 91.5 | 90.0 | 91.5 | 91.5 | 89.0 | 91.0 |
| transmittance at | | | | | | | | | | |
| 400-800 nm (%) | | | | | | | | | | |
| Light transmittance | 92.0 | 92.0 | 92.0 | 92.0 | 92.0 | 92.0 | 92.0 | 92.0 | 91.5 | 92.0 |
| at 550 nm wavelength | | | | | | | | | | |
| (%) | | | | | | | | | | |

TABLE 6

| Examples (wt %) | 11# | 12# | 13# | 14# | 15# | 16# | 17# | 18# | 19# | 20# |
|---|---|---|---|---|---|---|---|---|---|---|
| SiO₂ | 70.5 | 71 | 71.5 | 64 | 63 | 62 | 72 | 73 | 74 | 75 |
| Al₂O₃ | 8 | 6 | 10 | 9 | 8 | 8 | 6 | 6 | 6 | 6 |
| Li₂O | 8.5 | 7.5 | 8 | 8.5 | 9 | 5.5 | 7 | 7 | 7 | 6.5 |
| ZrO₂ | 6 | 6 | 6 | 9 | 12 | 12 | 7 | 7 | 6.5 | 6.5 |
| Na₂O | 5 | 5.5 | 4.5 | 5.5 | 4 | 8 | 4.5 | 4.5 | 4.5 | 4.5 |
| K₂O | 0 | 0 | 0 | 0 | 0 | 0 | 0.5 | 0 | 0 | 0 |
| P₂O₅ | 2 | 4 | 0 | 2 | 0 | 0 | 2 | 2 | 2 | 1.5 |
| ZnO | 0 | 0 | 0 | 1 | 0 | 2 | 0 | 0.5 | 0 | 0 |
| MgO | 0 | 0 | 0 | 1 | 2 | 0 | 0.5 | 0 | 0 | 0 |
| B₂O₃ | 0 | 0 | 0 | 0 | 2 | 2.5 | 0 | 0 | 0 | 0 |
| La₂O₃ | 0 | 0 | 0 | 0 | 0 | 0 | 0.5 | 0 | 0 | 0 |
| Gd₂O₃ | 0 | 0 | 0 | 0 | 0 | 0 | 0 | 0 | 0 | 0 |
| Y₂O₃ | 0 | 0 | 0 | 0 | 0 | 0 | 0 | 0 | 0 | 0 |
| Yb₂O₃ | 0 | 0 | 0 | 0 | 0 | 0 | 0 | 0 | 0 | 0 |
| Sb₂O₃ | 0 | 0 | 0 | 0 | 0 | 0 | 0 | 0 | 0 | 0 |
| In total | 100 | 100 | 100 | 100 | 100 | 100 | 100 | 100 | 100 | 100 |
| SiO₂/ZrO₂ | 11.8 | 11.8 | 11.9 | 7.1 | 5.3 | 5.2 | 10.3 | 10.4 | 11.4 | 11.5 |
| (SiO₂ + Li₂O)/(ZrO₂ + | 9.9 | 7.9 | 13.3 | 6.6 | 6.0 | 5.6 | 8.8 | 8.9 | 9.5 | 10.2 |
| P₂O₅) | | | | | | | | | | |
| (SiO₂ + Al₂O₃ + | 9.8 | 11.0 | 10.8 | 9.2 | 8.3 | 14.2 | 11.8 | 11.9 | 12.1 | 13.2 |
| Na₂O)/Li₂O | | | | | | | | | | |
| (ZrO₂ + Al₂O₃)/Li₂O | 1.6 | 1.6 | 2.0 | 2.1 | 2.2 | 3.6 | 1.9 | 1.9 | 1.8 | 1.9 |
| (Li₂O + Na₂O)/(SiO₂ + | 0.18 | 0.17 | 0.16 | 0.19 | 0.17 | 0.18 | 0.15 | 0.14 | 0.14 | 0.13 |
| ZrO₂) | | | | | | | | | | |
| Crystalline phase | Lithium | Lithium | Lithium | Lithium | Lithium | Lithium | Lithium | Lithium | Lithium | Lithium |
| | monosili- | monosili- | monosili- | monosili- | monosili- | monosili- | monosili- | monosili- | monosili- | monosili- |
| | cate | cate | cate | cate | cate | cate | cate | cate | cate | cate |
| Crystallinity (%) | 24 | 27 | 18 | 21 | 23 | 25 | 13 | 21 | 25 | 23 |
| Surface stress | 236 | 247 | 254 | 286 | 187 | 173 | 212 | 210 | 220 | 135 |
| (MPa) | | | | | | | | | | |
| Depth of ion | 144 | 125 | 115 | 115 | 133 | 129 | 110 | 111 | 113 | 125 |
| exchange layer | | | | | | | | | | |
| (μm) | | | | | | | | | | |
| Falling ball test | 1600 | 1600 | 1600 | 1600 | 1600 | 1600 | 1800 | 1600 | 1600 | 1600 |
| height (mm) | | | | | | | | | | |
| Drop resistance | 1800 | 1800 | 1600 | 1800 | 1800 | 2000 | 1800 | 2000 | 1800 | 1800 |
| (mm) | | | | | | | | | | |
| Fracture | 1.4 | 1.5 | 1.6 | 1.4 | 1.2 | 1.2 | 1.4 | 1.3 | 1.4 | 1.4 |
| toughness | | | | | | | | | | |
| (MPa · m^{1/2}) | | | | | | | | | | |
| Four-point | 725 | 729 | 715 | 702 | 737 | 729 | 726 | 709 | 708 | 698 |
| bending strength | | | | | | | | | | |
| (MPa) | | | | | | | | | | |
| Grain size (nm) | 27 | 28 | 26 | 27 | 35 | 40 | 25 | 28 | 27 | 35 |
| Vickers hardness | 705 | 709 | 732 | 715 | 719 | 718 | 728 | 721 | 700 | 685 |
| (kgf/mm²) | | | | | | | | | | |
| Haze (%) | 0.16 | 0.16 | 0.2 | 0.12 | 0.15 | 0.15 | 0.13 | 0.11 | 0.12 | 0.12 |
| \| B \| value | 0.88 | 0.85 | 0.87 | 0.73 | 0.82 | 0.83 | 0.68 | 0.64 | 0.67 | 0.78 |
| Average light | 90.0 | 90.5 | 90.5 | 91.0 | 89.0 | 90.0 | 90.5 | 91.0 | 90.5 | 91.0 |
| transmittance at | | | | | | | | | | |
| 400-800 nm (%) | | | | | | | | | | |
| Light | 92.0 | 92.0 | 92.0 | 92.0 | 91.5 | 92.0 | 92.0 | 92.0 | 92.0 | 92.0 |
| transmittance at | | | | | | | | | | |
| 550 nm | | | | | | | | | | |
| wavelength (%) | | | | | | | | | | |

1-54. (canceled)

55. A microcrystalline glass product, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.

56. The microcrystalline glass product according to claim 55, wherein components thereof are represented by weight percentage, further comprising: 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.

57. The microcrystalline glass product according to claim 55, wherein components thereof are represented by weight percentage, and one or more of the following 5 conditions are satisfied:
1) SiO₂/ZrO₂ is 5.0-15.0;
2) (SiO₂+Li₂O)/(ZrO₂+P₂O₅) is 5.0-13.5;
3) (SiO₂+Al₂O₃+Na₂O)/Li₂O is 7.0-18.0;
4) (ZrO₂+Al₂O₃)/Li₂O is 0.85-5.0;
5) (Li₂O+Na₂O)/(SiO₂+ZrO₂) is 0.10-0.27.

58. The microcrystalline glass product according to claim 55, wherein components thereof are represented by weight percentage, and one or more of the following 5 conditions are satisfied:
1) SiO₂/ZrO₂ is 6.5-12.0;
2) (SiO₂+Li₂O)/(ZrO₂+P₂O₅) is 6.0-11.5;
3) (SiO₂+Al₂O₃+Na₂O)/Li₂O is 7.5-15.0;
4) (ZrO₂+Al₂O₃)/Li₂O is 0.9-4.0;
5) (Li₂O+Na₂O)/(SiO₂+ZrO₂) is 0.12-0.25.

59. The microcrystalline glass product according to claim 55, wherein components thereof are represented by weight percentage, and one or more of the following 5 conditions are satisfied:
1) SiO₂/ZrO₂ is 7.0-11.0;
2) (SiO₂+Li₂O)/(ZrO₂+P₂O₅) is 6.0-10.5;
3) (SiO₂+Al₂O₃+Na₂O)/Li₂O is 8.5-11.0;
4) (ZrO₂+Al₂O₃)/Li₂O is 1.0-3.0;
5) (Li₂O+Na₂O)/(SiO₂+ZrO₂) is 0.15-0.23.

60. The microcrystalline glass product according to claim 55, wherein components thereof are represented by weight percentage, comprising: 64-75% of SiO₂; and/or 5-10% of Al₂O₃; and/or greater than or equal to 6% but less than 10% of Li₂O; and/or 4.5-7% of Na₂O; and/or 1.5-4% of P₂O₅; and/or 6-12% of ZrO₂; and/or 0-1% of ZnO; and/or 0-1% of MgO; and/or 0-2% of B₂O₃; and/or 0-2% of K₂O; and/or 0-1% of Ln₂O₃; and/or 0-1% of clarifying agent, and the Ln₂O₃ is one or more of La₂O₃, Gd₂O₃, Y₂O₃, and Yb₂O₃.

61. The microcrystalline glass product according to claim 55, wherein the microcrystalline glass product comprises lithium silicate crystalline phase, the lithium silicate crystalline phase has a higher weight percentage than other crystalline phases, the lithium silicate crystalline phase accounts for 5-50% of the microcrystalline glass product by weight percentage.

62. The microcrystalline glass product according to claim 55, wherein the microcrystalline glass product comprises lithium monosilicate crystalline phase, the lithium monosilicate crystalline phase has a higher weight percentage than other crystalline phases, the lithium monosilicate crystalline phase accounts for 5-50% of the microcrystalline glass product by weight percentage; and/or wherein the microcrystalline glass product comprises lithium disilicate crystalline phase, the lithium disilicate crystalline phase accounts for below 20% of the microcrystalline glass product by weight percentage; and/or wherein the microcrystalline glass product comprises petalite crystalline phase, the petalite crystalline phase accounts for below 15% of the microcrystalline glass product by weight percentage.

63. The microcrystalline glass product according to claim 55, wherein the microcrystalline glass product comprises lithium monosilicate crystalline phase, the lithium monosilicate crystalline phase has a higher weight percentage than other crystalline phases, the lithium monosilicate crystalline phase accounts for 10-30% of the microcrystalline glass product by weight percentage; and/or wherein the microcrystalline glass product comprises lithium disilicate crystalline phase, the lithium disilicate crystalline phase accounts for below 5% of the microcrystalline glass product by weight percentage; and/or wherein the microcrystalline glass product comprises petalite crystalline phase, the petalite crystalline phase accounts for below 5% of the microcrystalline glass product by weight percentage.

64. The microcrystalline glass product according to claim 55, wherein falling ball test height of the microcrystalline glass product is above 1600 mm; and/or fracture toughness is above 1.2 MPa-mm; and/or four-point bending strength is above 700 MPa; and/or Vickers hardness is above 700 kgf/mm²; and/or depth of ion exchange layer is above 100 μm; and/or surface stress is above 200 MPa; and/or crystallinity is above 20%; and/or grain size is below 30 nm; and/or drop resistance is above 1800 mm; and/or the haze of the microcrystalline glass product with a thickness of below 1 mm is below 0.15%; and/or average light transmittance at 400-800 nm wavelength of the microcrystalline glass product with a thickness of below 1 mm is above 90.5%; and/or light transmittance at 550 nm wavelength of the microcrystalline glass product with a thickness of below 1 mm is above 91.5%; and/or average light |B| value of 400-800 nm of the microcrystalline glass product with a thickness of below 1 mm is below 0.8.

65. A microcrystalline glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.

66. The microcrystalline glass according to claim 65, wherein components thereof are represented by weight percentage, further comprising: 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.

67. The microcrystalline glass according to claim 65, wherein components thereof are represented by weight percentage, and one or more of the following 5 conditions are satisfied:
1) SiO₂/ZrO₂ is 5.0-15.0;
2) (SiO₂+Li₂O)/(ZrO₂+P₂O₅) is 5.0-13.5;
3) (SiO₂+Al₂O₃+Na₂O)/Li₂O is 7.0-18.0;
4) (ZrO₂+Al₂O₃)/Li₂O is 0.85-5.0;
5) (Li₂O+Na₂O)/(SiO₂+ZrO₂) is 0.10-0.27.

68. The microcrystalline glass according to claim 65, wherein components thereof are represented by weight percentage, and one or more of the following 5 conditions are satisfied:
1) SiO₂/ZrO₂ is 6.5-12.0;
2) (SiO₂+Li₂O)/(ZrO₂+P₂O₅) is 6.0-11.5;
3) (SiO₂+Al₂O₃+Na₂O)/Li₂O is 7.5-15.0;
4) (ZrO₂+Al₂O₃)/Li₂O is 0.9-4.0;
5) (Li₂O+Na₂O)/(SiO₂+ZrO₂) is 0.12-0.25.

69. The microcrystalline glass according to claim 65, wherein components thereof are represented by weight percentage, and one or more of the following 5 conditions are satisfied:
1) SiO₂/ZrO₂ is 7.0-11.0;
2) (SiO₂+Li₂O)/(ZrO₂+P₂O₅) is 6.0-10.5;
3) (SiO₂+Al₂O₃+Na₂O)/Li₂O is 8.5-11.0;
4) (ZrO₂+Al₂O₃)/Li₂O is 1.0-3.0;
5) (Li₂O+Na₂O)/(SiO₂+ZrO₂) is 0.15-0.23.

70. The microcrystalline glass according to claim 65, wherein components thereof are represented by weight percentage, comprising: 64-75% of SiO₂; and/or 5-10% of Al₂O₃; and/or greater than or equal to 6% but less than 10% of Li₂O; and/or 4.5-7% of Na₂O; and/or 1.5-4% of P₂O₅; and/or 6-12% of ZrO₂; and/or 0-1% of ZnO; and/or 0-1% of MgO; and/or 0-2% of B₂O₃; and/or 0-2% of K₂O; and/or 0-1% of Ln₂O₃; and/or 0-1% of clarifying agent, and the Ln₂O₃ is one or more of La₂O₃, Gd₂O₃, Y₂O₃, and Yb₂O₃.

71. The microcrystalline glass according to claim 65, wherein the microcrystalline glass comprises lithium silicate crystalline phase, the lithium silicate crystalline phase has a higher weight percentage than other crystalline phases, the lithium silicate crystalline phase accounts for 5-50% of the microcrystalline glass by weight percentage.

72. The microcrystalline glass according to claim 65, wherein the microcrystalline glass comprises lithium monosilicate crystalline phase, the lithium monosilicate crystalline phase has a higher weight percentage than other crystalline phases, the lithium monosilicate crystalline phase accounts for 5-50% of the microcrystalline glass by weight percentage; and/or wherein the microcrystalline glass product comprises lithium disilicate crystalline phase, the lithium disilicate crystalline phase accounts for below 20% of the microcrystalline glass by weight percentage; and/or wherein the microcrystalline glass comprises petalite crystalline phase, the petalite crystalline phase accounts for below 15% of the microcrystalline glass by weight percentage.

73. The microcrystalline glass according to claim 65, wherein the microcrystalline glass comprises lithium monosilicate crystalline phase, the lithium monosilicate crystalline phase has a higher weight percentage than other crystalline phases, the lithium monosilicate crystalline phase accounts for 10-30% of the microcrystalline glass by weight percentage; and/or wherein the microcrystalline glass comprises lithium disilicate crystalline phase, the lithium disilicate crystalline phase accounts for below 5% of the microcrystalline glass by weight percentage; and/or wherein the microcrystalline glass comprises petalite crystalline phase, the petalite crystalline phase accounts for below 5% of the microcrystalline glass by weight percentage.

74. The microcrystalline glass according to claim 65, wherein crystallinity of the microcrystalline glass is above 20%; and/or grain size is below 30 nm; and/or body falling ball height is above 2000 mm; and/or Vickers hardness is above 630 kgf/mm²; and/or refractive index is 1.520-1.545; and/or Young's modulus is 80-100 GPa; and/or wherein haze of the microcrystalline glass with a thickness of below 1 mm is below 0.15%; and/or average light transmittance at 400-800 nm wavelength of the microcrystalline glass with a thickness of below 1 mm is above 90.5%; and/or light transmittance at 550 nm wavelength of the microcrystalline glass with a thickness of below 1 mm is above 91.5%; and/or average light |B| value of 400-800 nm of the microcrystalline glass with a thickness of below 1 mm is below 0.8.

75. A matrix glass, wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.

76. The matrix glass according to claim 75, wherein components thereof are represented by weight percentage, further comprising: 0-2% of ZnO; and/or 0-2% of MgO; and/or 0-4% of B₂O₃; and/or 0-3% of K₂O; and/or 0-2% of Ln₂O₃; and/or 0-2% of clarifying agent, and the Ln₂O₃ is one or more of La₂O₃, Gd₂O₃, Y₂O₃, and Yb₂O₃.

77. The matrix glass according to claim 75, wherein components thereof are represented by weight percentage, and one or more of the following 5 conditions are satisfied:
1) SiO₂/ZrO₂ is 5.0-15.0;
2) (SiO₂+Li₂O)/(ZrO₂+P₂O₅) is 5.0-13.5;
3) (SiO₂+Al₂O₃+Na₂O)/Li₂O is 7.0-18.0;
4) (ZrO₂+Al₂O₃)/Li₂O is 0.85-5.0;
5) (Li₂O+Na₂O)/(SiO₂+ZrO₂) is 0.10-0.27.

78. The matrix glass according to claim 75, wherein components thereof are represented by weight percentage, and one or more of the following 5 conditions are satisfied:
1) SiO₂/ZrO₂ is 6.5-12.0;
2) (SiO₂+Li₂O)/(ZrO₂+P₂O₅) is 6.0-11.5;
3) (SiO₂+Al₂O₃+Na₂O)/Li₂O is 7.5-15.0;
4) (ZrO₂+Al₂O₃)/Li₂O is 0.9-4.0;
5) (Li₂O+Na₂O)/(SiO₂+ZrO₂) is 0.12-0.25.

79. The matrix glass according to claim 75, wherein components thereof are represented by weight percentage, and one or more of the following 5 conditions are satisfied:
1) SiO₂/ZrO₂ is 7.0-11.0;
2) (SiO₂+Li₂O)/(ZrO₂+P₂O₅) is 6.0-10.5;
3) (SiO₂+Al₂O₃+Na₂O)/Li₂O is 8.5-11.0;
4) (ZrO₂+Al₂O₃)/Li₂O is 1.0-3.0;
5) (Li₂O+Na₂O)/(SiO₂+ZrO₂) is 0.15-0.23.

80. The matrix glass according to claim 75, wherein components thereof are represented by weight percentage, comprising: 64-75% of SiO₂; and/or 5-10% of Al₂O₃; and/or greater than or equal to 6% but less than 10% of Li₂O; and/or 4.5-7% of Na₂O; and/or 1.5-4% of P₂O₅; and/or 6-12% of ZrO₂; and/or 0-1% of ZnO; and/or 0-1% of MgO; and/or 0-2% of B₂O₃; and/or 0-2% of K₂O; and/or 0-1% of Ln₂O₃; and/or 0-1% of clarifying agent, and the Ln₂O₃ is one or more of La₂O₃, Gd₂O₃, Y₂O₃, and Yb₂O₃.

81. A glass cover plate, comprising the microcrystalline glass product according to claim 55; and/or the microcrystalline glass wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5; and/or the matrix glass wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5.

82. An electronic device, comprising the microcrystalline glass product wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5; and/or the microcrystalline glass wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5; and/or the matrix glass wherein components thereof are represented by weight percentage, comprising: 60-80% of SiO₂; 3-15% of Al₂O₃; greater than or equal to 5% but less than 10% of Li₂O; 4-8% of Na₂O; 0.5-5% of P₂O₅; greater than 5% but less than or equal to 15% of ZrO₂, wherein (SiO₂+Li₂O)/(ZrO₂+P₂O₅) is 4.0-15.5; and/or the glass cover plate according to claim 81.

83. A manufacturing method of the microcrystalline glass product according to claim 55, wherein the method comprises the following steps: forming a matrix glass, forming the matrix glass into a microcrystalline glass through a crystallization process, and then forming the microcrystalline glass into a microcrystalline glass product through a chemical strengthening process.

84. The manufacturing method of the microcrystalline glass product according to claim 83, wherein the crystallization process comprises the following steps: heating up to a specified crystallization treatment temperature, holding the temperature for a certain time after reaching the crystallization treatment temperature, and then performing cooling, wherein the crystallization treatment temperature is 580-650° C., and holding time under the crystallization treatment temperature is 1-6 hours.

85. The manufacturing method of the microcrystalline glass product according to claim 83, wherein the crystallization process comprises the following steps: performing nucleation process treatment under a first temperature, and then performing crystal growth process treatment under a second temperature that is higher than the nucleation process temperature, the first temperature is 450-550° C., and the second temperature is 550-700° C.; the holding time under the first temperature is 2-15 hours; the holding time under the second temperature is 0.5-6 hours.

86. The manufacturing method of the microcrystalline glass product according to claim 83, wherein the chemical strengthening process comprises: immersing the microcrystalline glass into a salt bath of molten Na salt at a temperature of 350° C.-470° C. for 1-36 hours; and/or immersing the microcrystalline glass into a salt bath of molten K salt at a temperature of 360° C.-450° C. for 1-36 hours; and/or immersing the microcrystalline glass into a mixed salt bath of molten K salt and Na salt at a temperature of 360° C.-450° C. for 1-36 hours.

87. The manufacturing method of the microcrystalline glass according to claim 65, wherein the method comprises the following steps: forming a matrix glass, and then forming the matrix glass into a microcrystalline glass through a crystallization process.

88. The manufacturing method of the microcrystalline glass according to claim 87, wherein the crystallization process comprises the following steps: heating up to a specified crystallization treatment temperature, holding the temperature for a certain time after reaching the crystallization treatment temperature, and then performing cooling, wherein the crystallization treatment temperature is 580-650° C., and holding time under the crystallization treatment temperature is 1-6 hours.

89. The manufacturing method of the microcrystalline glass according to claim 87, wherein the crystallization process comprises the following steps: performing nucleation process treatment under a first temperature, and then performing crystal growth process treatment under a second temperature that is higher than the nucleation process temperature, the first temperature is 450-550° C., and the second temperature is 550-700° C.; the holding time under the first temperature is 2-15 hours; the holding time under the second temperature is 0.5-6 hours.
